(19) United States
(12) Patent Application Publication
(10) Pub. No.: US 2023/0142762 A1
(43) Pub. Date: May 11, 2023

(54) SENSING SYSTEM

(71) Applicant: Sony Group Corporation, Tokyo (JP)

(72) Inventor: Kei Nakagawa, Kanagawa (JP)

(21) Appl. No.: 17/995,389

(22) PCT Filed: Feb. 18, 2021
(86) PCT No.: PCT/JP2021/006034

§ 371 Date: Oct. 3, 2022

(30) Foreign Application Priority Data
May 20, 2020 (JP) 2020-087854

(51) Int. Cl. G01S 7/4865; G01S 17/894; G01S 7/481; G01S 17/931

(52) U.S. Cl. CPC G01S 7/4865; G01S 7/4816; G01S 17/894; G01S 17/931

(57) ABSTRACT

In a system that captures image data, a distance to an object is measured without adding a range sensor.

A light emitting unit applies invisible light in synchronization with a predetermined light emission control signal. An invisible light pixel photoelectrically converts reflected light with respect to the invisible light to generate a pulse signal as an invisible light pulse signal. A visible light pixel photoelectrically converts visible light to generate a pulse signal as a visible light pulse signal. A counting unit performs processing for counting a number of the visible light pulse signals and perform processing for counting, in synchronization with the light emission control signal, a number of the invisible light pulse signals.

### TECHNICAL FIELD

The present technology relates to a sensing system. Specifically, the present technology relates to a sensing system that counts the number of pulses generated by a pixel in response to incidence of photons.

### BACKGROUND ART

In recent years, a device called a single photon avalanche diode (SPAD) has been developed and studied and the device captures very weak optical signals to realize optical communication, distance measurement, photon counting, and so on. The SPAD is an avalanche photodiode that is sensitive enough to detect a single photon. For example, a solid-state imaging element has been proposed in which a pixel that generates a pulse signal using the SPAD and a counter that counts the number of pulse signals within an exposure period are arranged (see, for example, Patent Document 1).

### Citation List

### Patent Document

Patent Document 1: WO 2019/150785 A

### SUMMARY OF THE INVENTION

### Problems to Be Solved by the Invention

In the conventional technology described above, a high-sensitivity SPAD is used to detect weak light, which improves image quality for a case where an image is captured in a dark environment. However, the solid-state imaging element described above cannot measure a distance to an object in the captured image. In a case where a range sensor using infrared rays or lasers is added to perform distance measurement, the power consumption and cost of a system increase, which is not preferable.

The present technology has been made in light of such a situation, and an object thereof is to measure a distance to an object without adding a range sensor in a system that captures image data.

### SOLUTIONS TO PROBLEMS

The present technology has been made to solve the issue described above, and a first aspect thereof is a sensing system including: a light emitting unit configured to apply invisible light in synchronization with a predetermined light emission control signal; an invisible light pixel configured to photoelectrically convert reflected light with respect to the invisible light to generate a pulse signal as an invisible light pulse signal; a visible light pixel configured to photoelectrically convert visible light to generate a pulse signal as a visible light pulse signal; and a counting unit configured to perform processing for counting a number of the visible light pulse signals and perform processing for counting, in synchronization with the light emission control signal, a number of the invisible light pulse signals. The configuration produces an effect of capturing image data and performing distance measurement.

Further, in the first aspect, the visible light pixel may include first, second, and third visible light pixels that photoelectrically convert visible light different from each other, the invisible light pixel may include first, second, third, and fourth invisible light pixels correlated with enable signals of which phase difference with respect to the light emission control signal differs from each other, the first, second, third, and fourth invisible light pixels may be arranged adjacent to each other, and the first, second, and third visible light pixels may be arranged near the first invisible light pixel. The configuration produces an effect that the number of pulses of each of the first, second, and third visible light pixels and the first invisible light pixel is counted.

Further, in the first aspect, the counting unit may include a counter configured to perform, in a predetermined order, processing for counting the number of the visible light pulse signals of each of the first, second, and third visible light pixels and perform processing for counting the number of the invisible light pulse signals. The configuration produces an effect that four pixels share the counter.

Further, in the first aspect, the counting unit may include a first counter configured to count the number of the visible light pulse signals of the first visible light pixel, a second counter configured to count the number of the visible light pulse signals of the second visible light pixel, a third counter configured to count the number of the visible light pulse signals of the third visible light pixel, and a fourth counter configured to count the number of the invisible light pulse signals in synchronization with the light emission control signal. The configuration produces an effect that the number of pulses of each of the four pixels is counted in parallel.

Further, in the first aspect, the visible light pixel may include first, second, and third visible light pixels that photoelectrically convert same visible light, the invisible light pixel may include first, second, third, and fourth invisible light pixels correlated with enable signals of which phase difference with respect to the light emission control signal differs from each other, and the first, second, and third visible light pixels may be arranged near the first invisible light pixel. The configuration produces an effect that the number of pulses of each of the first, second, and third visible light pixels and the first invisible light pixel is counted.

Further, in the first aspect, the counting unit may include a selector configured to sequentially select, as an input signal, the visible light pulse signal of each of the first, second, and third visible light pixels, a first counter configured to count a number of the input signals, and a second counter configured to count a number of the invisible light pulse signals in synchronization with the light emission control signal. The configuration produces an effect that the number of pulses of each of the visible light pixel and the invisible light pixel is counted in parallel.

Further, in the first aspect, the counting unit my include a logical sum gate configured to output a logical sum of the invisible light pulse signal of each of the first, second, and third visible light pixels, a selector configured to select, as an input signal, any of the invisible light pulse signal of each of the first, second, and third visible light pixels, the logical sum, and the visible light pulse signal, and a counter configured to count a number of the input signals. The configuration produces an effect of adding four pixels.

Further, in the first aspect, the visible light pixel may include a red (R) pixel, a green (G) pixel, and a blue (B) pixel, and the invisible light pixel is arranged at a position of the G pixel in the Bayer array. The configuration produces an effect of simplifying demosaicing.

Further, in the first aspect, the invisible light pixel may include a plurality of invisible light pixels correlated with enable signals of which phase difference with respect to the light emission control signal differs from each other, and the plurality of invisible light pixels may be arranged in a predetermined direction. The configuration produces an effect of increasing the number of pixels of the invisible light pixels in the predetermined direction.

Further, in the first aspect, the visible light pixel may be inserted between each of the plurality of invisible light pixels. The configuration produces an effect of reducing the number of pixels to be interpolated.

Further, in the first aspect, the visible light pixel may include first, second, third, and fourth visible light pixels that are arranged adjacent to each other, the invisible light pixel may include first, second, third, and fourth invisible light pixels that are arranged adjacent to each other, and the first, second, third, and fourth visible light pixels may photoelectrically convert visible light different from each other. The configuration produces an effect of increasing a range-finding point.

Further, in the first aspect, the counting unit may include a plurality of counters that counts the number of the invisible light pulse signals in synchronization with enable signals of which phase difference with respect to the light emission control signal differs from each other. The configuration produces an effect that the number of pulses is counted in parallel for a plurality of phases.

Further, in the first aspect, the counting unit may include a selector configured to select, as an input signal, any of the visible light pulse signal of each of the first, second, and third visible light pixels, and a counter configured to count a number of the input signals. The configuration produces an effect that a plurality of pixels shares the counter.

Further, in the first aspect, the counting unit may include a first counter configured to count a number of the invisible light pulse signals in synchronization with a first enable signal in which a phase difference with respect to the light emission control signal is set at 0 degrees or 180 degrees, and a second counter configured to count a number of the invisible light pulse signals in synchronization with a second enable signal in which a phase difference with respect to the light emission control signal is set at 90 degrees or 270 degrees. The configuration produces an effect of reducing the number of counters.

Further, in the first aspect, the counting unit may include a logical circuit configured to output a logical sum of two or more of the invisible light pulse signal of each of the first, second, third, and fourth invisible light pixels, a selector configured to select any of the invisible light pulse signal of the first invisible light pixel and the logical sum and output a resultant as an input signal, a fifth counter configured to count a number of the input signals, a sixth counter configured to count the number of the invisible light pulse signals of the second invisible light pixel, a seventh counter configured to count the number of the invisible light pulse signals of the third invisible light pixel, and an eighth counter configured to count the number of the invisible light pulse signals of the fourth invisible light pixel. The configuration produces an effect that the number of pulses of the first to fourth invisible light pixels is counted in parallel.

Further, in the first aspect, the counting unit may include a logical circuit configured to output a logical product of a logical sum of the invisible light pulse signal of each of the first, second, third, and fourth invisible light pixels and each of first and second enable signals of which phase difference with respect to the light emission synchronization signal differs from each other, a selector configured to select any of the invisible light pulse signal of the first invisible light pixel and the logical product and output a resultant as an input signal, a fifth counter configured to count a number of the input signals, a sixth counter configured to count the number of the invisible light pulse signals of the second invisible light pixel, a seventh counter configured to count the number of the invisible light pulse signals of the third invisible light pixel, and an eighth counter configured to count the number of the invisible light pulse signals of the fourth invisible light pixel. The configuration produces an effect of adding a plurality of pixels.

Further, in the first aspect, the counting unit may include a logical circuit configured to output a logical product of a logical sum of the invisible light pulse signal of each of the first, second, third, and fourth invisible light pixels and each of first and second enable signals of which phase difference with respect to the light emission synchronization signal differs from each other, a selector configured to select any of the invisible light pulse signal of the first invisible light pixel and the logical product corresponding to the first enable signal and output a resultant as an input signal, a switch configured to output the logical product corresponding to the first enable signal in accordance with a predetermined control signal, a fifth counter configured to count a number of the input signals, and a sixth counter configured to perform counting on the basis of the logical product outputted by the second switch. The configuration produces an effect of reducing the number of counters.

Further, in the first aspect, the visible light pixel may include first, second, third, and fourth visible light pixels that are arranged adjacent to each other, the invisible light pixel may include first, second, third, and fourth invisible light pixels that are arranged adjacent to each other, and the first, second, third, and fourth visible light pixels may photoelectrically convert same visible light. The configuration produces an effect that the number of pulses of the first, second, third and fourth visible light pixels having the same color is counted.

Further, in the first aspect, the first and second visible light pixels may receive one of a pair of incident light subjected to pupil division, the third and fourth visible light pixels may receive the other of the pair of incident light subjected to the pupil division, and the counting unit may include a first logical sum gate configured to output, as a first logical sum, a logical sum of the visible light pulse signal of each of the first and second visible light pixels, a first selector configured to select any of the first logical sum and the visible light pulse signal of each of the first and second visible light pixels and output a resultant as a first input signal, a second logical sum gate configured to output, as a second logical sum, a logical sum of the visible light pulse signal of each of the third and fourth visible light pixels, a second selector configured to select any of the second logical sum and the visible light pulse signal of each of the third and fourth visible light pixels and output a resultant as a second input signal, a first counter configured to count a number of the first input signals, and a second counter configured to count a number of the second input signals. The configuration produces an effect that focus is detected by an image plane phase difference method.

Further, in the first aspect, the counting unit may further include a third logical gate configured to output, as a third logical sum, a logical sum of the first logical sum and the second logical sum to the first selector, and the first selector selects any of the third logical sum, the first logical sum, and the visible light pulse signal of each of the first and second visible light pixels. The configuration produces an effect of adding a plurality of pixels.

### BRIEF DESCRIPTION OF DRAWINGS

FIG. 1 is a block diagram illustrating an example of the configuration of a sensing system according to a first embodiment of the present technology.

FIG. 2 is a diagram illustrating an example of a stacked structure of a solid-state imaging element according to the first embodiment of the present technology.

FIG. 3 is a block diagram illustrating an example of the configuration of a solid-state imaging element according to the first embodiment of the present technology.

FIG. 4 is an example of a plan view of a pixel array unit according to the first embodiment of the present technology.

FIG. 5 is a block diagram illustrating an example of the configuration of a pixel block according to the first embodiment of the present technology.

FIG. 6 is a circuit diagram illustrating an example of the configuration of a pixel according to the first embodiment of the present technology.

FIG. 7 is a circuit diagram illustrating an example of the configuration of a circuit block according to the first embodiment of the present technology.

FIG. 8 is an explanatory diagram of the operation of a counter according to the first embodiment of the present technology.

FIG. 9 is a timing chart illustrating an example of the operation in a ranging mode of a solid-state imaging element according to the first embodiment of the present technology.

FIG. 10 is a timing chart illustrating an example of the operation in an imaging mode of a solid-state imaging element according to the first embodiment of the present technology.

FIG. 11 is an example of an overall view of a sensing system according to the first embodiment of the present technology.

FIG. 12 is a flowchart depicting an example of the operation of a sensing system according to the first embodiment of the present technology.

FIG. 13 is a block diagram illustrating an example of the configuration of a pixel block according to a modification example to the first embodiment of the present technology.

FIG. 14 is a circuit diagram illustrating an example of the configuration of a circuit block according to a modification example to the first embodiment of the present technology.

FIG. 15 is an explanatory diagram of the operation of a counter according to a modification example to the first embodiment of the present technology.

FIG. 16 is an example of a plan view of a pixel array unit according to a second embodiment of the present technology.

FIG. 17 is a block diagram illustrating an example of the configuration of a pixel block according to the second embodiment of the present technology.

FIG. 18 is a circuit diagram illustrating an example of the configuration of a circuit block according to the second embodiment of the present technology.

FIG. 19 is a circuit diagram illustrating an example of the configuration of a circuit block according to a modification example to the second embodiment of the present technology.

FIG. 20 is an example of a plan view of a pixel array unit according to a third embodiment of the present technology.

FIG. 21 is an example of a plan view of a pixel array unit according to a fourth embodiment of the present technology.

FIG. 22 is an example of a plan view of a pixel array unit according to a modification example to the fourth embodiment of the present technology.

FIG. 23 is an example of a plan view of a pixel array unit according to a fifth embodiment of the present technology.

FIG. 24 is a block diagram illustrating an example of the configuration of a pixel block in which visible light pixels are arranged according to the fifth embodiment of the present technology.

FIG. 25 is a block diagram illustrating an example of the configuration of a pixel block in which infrared (IR) pixels are arranged according to the fifth embodiment of the present technology.

FIG. 26 is a circuit diagram illustrating an example of the configuration of a circuit block according to the fifth embodiment of the present technology.

FIG. 27 is an explanatory diagram of the operation of a counter according to the fifth embodiment of the present technology.

FIG. 28 is a block diagram illustrating an example of the configuration of a pixel block in which visible light pixels are arranged according to a first modification example to the fifth embodiment of the present technology.

FIG. 29 is a block diagram illustrating an example of the configuration of a pixel block in which IR pixels are arranged according to a second modification example to the fifth embodiment of the present technology.

FIG. 30 is a timing chart illustrating an example of the operation of a ranging mode of a solid-state imaging element according to the second modification example to the fifth embodiment of the present technology.

FIG. 31 is an example of a plan view of a pixel array unit according to a third modification example to the fifth embodiment of the present technology.

FIG. 32 is a circuit diagram illustrating an example of the configuration of a circuit block according to the third modification example to the fifth embodiment of the present technology.

FIG. 33 is an explanatory diagram of the operation of a pixel drive unit according to the third modification example to the fifth embodiment of the present technology.

FIG. 34 is a circuit diagram illustrating an example of the configuration of a circuit block according to a fourth modification example to the fifth embodiment of the present technology.

FIG. 35 is an explanatory diagram of the operation of a counter according to the fourth modification example to the fifth embodiment of the present technology.

FIG. 36 is a block diagram illustrating an example of the configuration of a pixel block in which IR pixels are arranged according to a fifth modification example to the fifth embodiment of the present technology.

FIG. 37 is a circuit diagram illustrating an example of the configuration of a circuit block according to the fifth modification example to the fifth embodiment of the present technology.

FIG. 38 is an explanatory diagram of the operation of a counter according to the fifth modification example to the fifth embodiment of the present technology.

FIG. 39 is an example of a plan view of a pixel array unit according to a sixth embodiment of the present technology.

FIG. 40 is a block diagram illustrating an example of the configuration of a pixel block in which visible light pixels are arranged according to the sixth embodiment of the present technology.

FIG. 41 is a circuit diagram illustrating an example of the configuration of a circuit block according to the sixth embodiment of the present technology.

FIG. 42 is a circuit diagram illustrating an example of the configuration of a circuit block according to a modification example to the sixth embodiment of the present technology.

FIG. 43 is an example of a plan view of a pixel array unit according to a seventh embodiment of the present technology.

FIG. 44 is an example of a plan view of a pixel array unit according to an eighth embodiment of the present technology.

FIG. 45 is a block diagram illustrating an example of the schematic configuration of a vehicle control system.

FIG. 46 is an explanatory diagram illustrating an example of the installation position of an imaging section.

### MODE FOR CARRYING OUT THE INVENTION

Modes for carrying out the present technology (hereinafter, referred to as embodiments) are described below. The description is given in the following order.

1. First Embodiment (example of counting the number of pulses of visible light pixels and IR pixels)

2. Second Embodiment (example of counting the number of pulses of three visible light pixels of same color and IR pixels)

3. Third Embodiment (example in which visible light pixels are inserted at positions of G pixels in the Bayer array and the number of pulses thereof is counted)

4. Fourth Embodiment (example in which IR pixels are arranged in a predetermined direction and the number of pulses of visible light pixels and IR pixels are counted)

5. Fifth Embodiment (example of counting the number of pulses of four visible light pixels in the Bayer array and four IR pixels)

6. Sixth Embodiment (example of counting the number of pulses of four visible light pixels in the Quadra array and four IR pixels)

7. Seventh Embodiment (example of counting the number of pulses of sixteen visible light pixels in the Bayer array and sixteen IR pixels)

8. Eighth Embodiment (example of counting the number of pulses of sixteen visible light pixels in the Quadra array and sixteen IR pixels)

9. Application Example to Mobile Object

### 1. First Embodiment

### Configuration Example of Sensing System

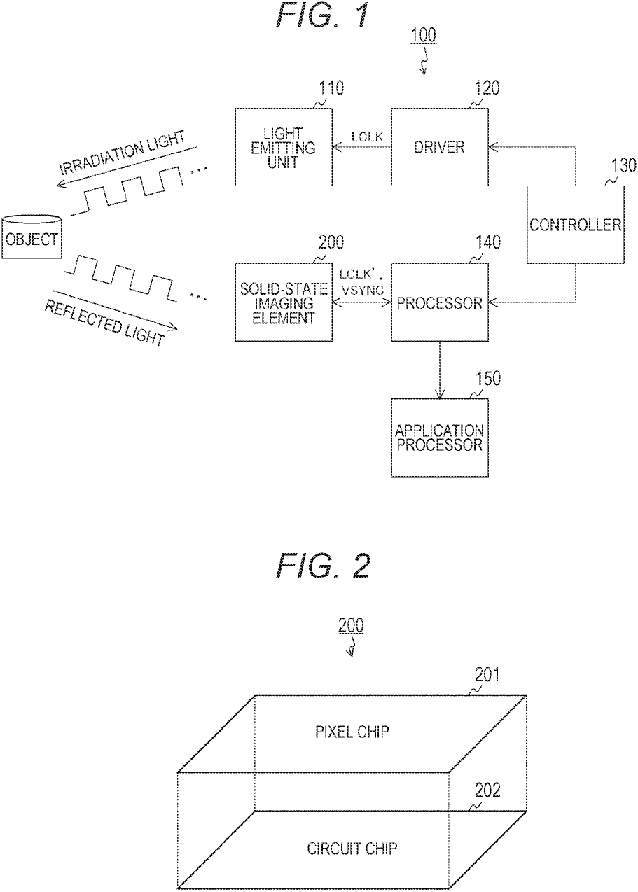

FIG. 1 is a block diagram illustrating an example of the configuration of a sensing system 100 according to the first embodiment of the present technology. The sensing system 100 is a system to capture image data and measure a distance. The sensing system 100 includes a light emitting unit 110, a driver 120, a controller 130, a solid-state imaging element 200, a processor 140, and an application processor 150.

Each element in the sensing system 100 may be placed in one electronic device, or may be dispersedly placed in a plurality of devices. In a case where the elements are dispersedly placed in a plurality of devices, for example, the light emitting unit 110, the driver 120, the controller 130, the solid-state imaging element 200, and the processor 140 are placed in an imaging device, and the application processor 150 is paced in an image processing device.

The light emitting unit 110 emits light in accordance with a light emission control signal LCLK from the driver 120 and applies irradiation light. The irradiation light is, for example, invisible light (near-infrared light or the like).

The driver 120 generates a predetermined periodic signal as the light emission control signal LCLK under the control of the controller 130 and supplies the periodic signal to the light emitting unit 110.

The controller 130 operates the driver 120 and the processor 140 in synchronization with each other. Here, a plurality of modes is set for the sensing system, and the modes include a ranging mode for measuring a distance to an object and an imaging mode for capturing image data. In the ranging mode, the controller 130 causes the driver 120 to generate the light emission control signal LCLK, and causes the processor 140 to generate the same signal as the light emission control signal LCLK as a light emission control signal LCLK’. On the other hand, in the imaging mode, the controller 130 stops the driver 120 and causes the processor 140 to generate a vertical synchronization signal VSYNC.

Here, the frequency of the vertical synchronization signal VSYNC is, for example, 30 hertz (Hz) or 60 hertz (Hz). On the other hand, the frequency of the light emission control signal LCLK is higher than that of the vertical synchronization signal VSYNC, and is, for example, 10 to 20 megahertz (MHz).

The processor 140 controls the solid-state imaging element 200 and the application processor 150. The processor 140 generates the light emission control signal LCLK’ in the ranging mode, supplies the light emission control signal LCLK’ to the solid-state imaging element 200, and receives a depth map from the solid-state imaging element 200. On the other hand, in the imaging mode, the processor 140 generates the vertical synchronization signal VSYNC, supplies the vertical synchronization signal VSYNC to the solid-state imaging element 200, and receives image data from the solid-state imaging element 200. Then, the processor 140 supplies the depth map and the image data to the application processor 150.

The application processor 150 performs predetermined processing such as image recognition processing on the basis of the image data and the depth map.

The solid-state imaging element 200 generates image data or a depth map by photoelectric conversion. In the ranging mode, the solid-state imaging element 200 photoelectrically converts reflected light with respect to the irradiation light in synchronization with the light emission control signal LCLK’, and generates a depth map. On the other hand, in the imaging mode, the solid-state imaging element 200 photoelectrically converts incident light in synchronization with the vertical synchronization signal VSYNC, and generates image data. The solid-state imaging element 200 supplies the image data or the depth map to the processor 140.

Note that another configuration is possible in which the solid-state imaging element 200 has some or all of the functions of the processor 140 and the application processor 150.

### Configuration Example of Solid-State Imaging Element

FIG. 2 is a diagram illustrating an example of a stacked structure of the solid-state imaging element 200 according to the first embodiment of the present technology. The solid-state imaging element 200 includes a circuit chip 202 and a pixel chip 201 stacked on the circuit chip 202. The chips are electrically connected to each other via a connection portion such as a via. Note that, aside from the via, the chips can also be connected by Cu-Cu bonding or a bump. The chips can also be connected by the other methods (such as magnetic coupling). Further, although the two chips are stacked, three or more layers can be stacked.

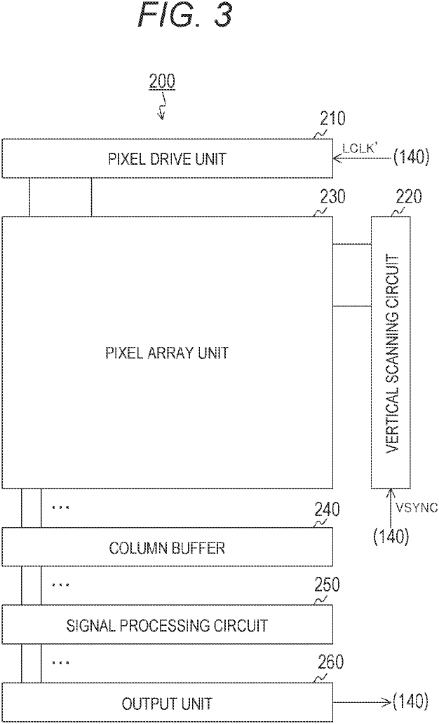

FIG. 3 is a block diagram illustrating an example of the configuration of the solid-state imaging element 200 according to the first embodiment of the present technology. The solid-state imaging element 200 includes a pixel drive unit 210, a vertical scanning circuit 220, a pixel array unit 230, a column buffer 240, a signal processing circuit 250, and an output unit 260. In the pixel array unit 230, a plurality of pixels is arranged in a two-dimensional lattice pattern.

The pixel drive unit 210 drives the pixels in the pixel array unit 230 in synchronization with the light emission control signal LCLK’ to count the number of pulses.

The vertical scanning circuit 220 sequentially selects rows of the pixels in synchronization with the vertical synchronization signal VSYNC, and outputs the count value to the column buffer 240.

The column buffer 240 holds the count value for each pixel.

The signal processing circuit 250 performs predetermined signal processing on data with an array of the count values. For example, in the ranging mode, the signal processing circuit 250 calculates distances for a plurality of range-finding points on the basis of the count values, and generates a depth map with an array of data on the distances. Further, in the imaging mode, the signal processing circuit 250 generates image data in which the count value for each pixel is arranged as pixel data, and performs various types of image processing on the image data. The signal processing circuit 250 then supplies the depth map and the image data to the processor 140.

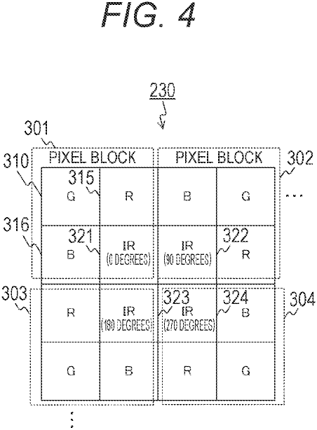

FIG. 4 is an example of a plan view of the pixel array unit 230 according to the first embodiment of the present technology. The pixel array unit 230 is divided into a plurality of pixel blocks including pixel blocks 301 to 304. In each pixel block, four pixels are arranged in two rows by two columns.

Referring to FIG. 4, for example, in the upper left pixel block 301, a red (R) pixel 315, a green (G) pixel 310, a blue (B) pixel 316, and an IR pixel 321 are arranged. In the upper right pixel block 302, an R pixel, a G pixel, a B pixel, and an IR pixel 322 are arranged. Further, in the lower left pixel block 303, an R pixel, a G pixel, a B pixel, and an IR pixel 323 are arranged. In the lower right pixel block 304, an R pixel, a G pixel, a B pixel, and an IR pixel 324 are arranged.

Further, in the upper left pixel block 301, the IR pixel 321 is arranged at the lower right, and in the upper right pixel block 302, the IR pixel 322 is arranged at the lower left. In the lower left pixel block 303, the IR pixel 323 is arranged at the upper right, and in the lower right pixel block 304, the IR pixel 324 is arranged at the upper left. With the arrangements, the IR pixels 321 to 324 are arranged adjacent to one another in two rows by two columns.

The R pixel 315 photoelectrically converts red visible light to generate a pulse signal. The G pixel 310 photoelectrically converts green visible light to generate a pulse signal. The B pixel 316 photoelectrically converts blue visible light to generate a pulse signal.

The IR pixels 321 to 324 photoelectrically convert reflected light with respect to the irradiation light (that is, infrared light) to generate pulse signals. The IR pixel 321, of the IR pixels 321 to 324, is a pixel of which the number of pulse signals is counted in synchronization with an enable signal having a phase difference of 0 degrees with respect to the light emission control signal LCLK. The IR pixel 322 is a pixel of which the number of pulse signals is counted in synchronization with an enable signal having a phase difference of 90 degrees with respect to the light emission control signal LCLK. The IR pixels 323 and 324 are pixels of which the number of pulse signals is counted in synchronization with enable signals having phase differences of 180 degrees and 270 degrees respectively with respect to the light emission control signal LCLK.

Further, in each of the pixel blocks 301 to 304, a circuit and an element such as a counter are further arranged in addition to the pixels including the G pixel 310. In FIG. 4, circuits and elements other than the pixels are omitted.

### Configuration Example of Pixel Block

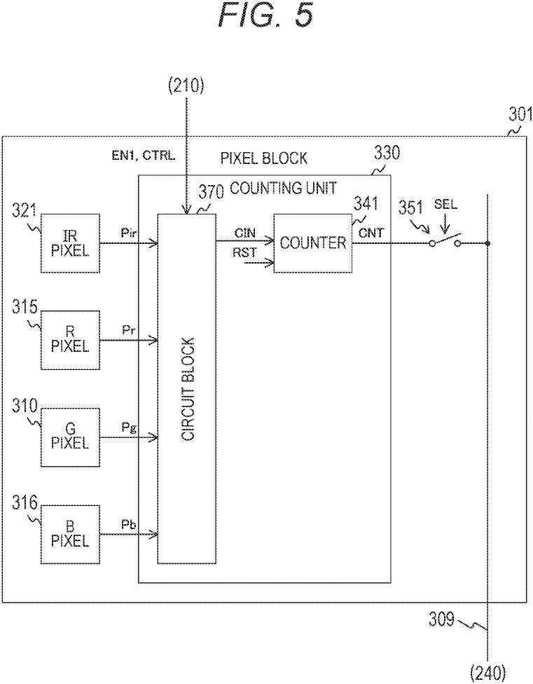

FIG. 5 is a block diagram illustrating an example of the configuration of the pixel block 301 according to the first embodiment of the present technology. The pixel block 301 includes the IR pixel 321, the R pixel 315, the G pixel 310, the B pixel 316, a counting unit 330, and a switch 351. In the counting unit 330, a circuit block 370 and a counter 341 are disposed.

The IR pixel 321 photoelectrically converts reflected light with respect to the irradiation light (that is, infrared light) to generate a pulse signal Pir. The R pixel 315 photoelectrically converts the red visible light to generate a pulse signal Pr. The G pixel 310 photoelectrically converts the green visible light to generate a pulse signal Pg. The B pixel 316 photoelectrically converts the blue visible light to generate a pulse signal Pb. The four pixels output the generated pulse signals to the circuit block 370.

The circuit block 370 controls output destinations of the pulse signals Pir, Pr, Pg, and Pb. In the imaging mode, the circuit block 370 sequentially selects the pulse signals Pir, Pr, Pg, and Pb, and outputs the selected signals to the counter 341 as an input signal CIN. On the other hand, in the ranging mode, the circuit block 370 outputs the pulse signal Pir to the counter 341 as the input signal CIN in synchronization with an enable signal EN1 from the pixel drive unit 210. Further, the circuit block 370 switches between the pulse signals in accordance with a control signal CTRL from the pixel drive unit 210.

The counter 341 counts the number of input signals CIN received. The counter 341 outputs the count value as a CNT to the switch 351. Further, the counter 341 receives an input of a reset signal RST from the vertical scanning circuit 220. The count value of the counter 341 is initialized by the reset signal RST. Incidentally, the pixel drive unit 210 can supply the reset signal RST instead of the vertical scanning circuit 220.

The switch 351 outputs the count value CNT to the column buffer 240 via a vertical signal line 309 in accordance with a selection signal SEL from the vertical scanning circuit 220.

The configuration of each of the pixel blocks 302 to 304 is similar to that of the pixel block 301. However, the pixel block 302 is supplied with an enable signal EN2. The pixel blocks 303 and 304 are supplied with enable signals EN3 and EN4, respectively.

Here, the enable signal EN1 is the same signal as the light emission control signal LCLK. The enable signal EN2 is a signal having a phase shifted, by 90 degrees, from the light emission control signal LCLK. The enable signal EN3 is a signal having a phase shifted, by 180 degrees, from the light emission control signal LCLK. The enable signal EN4 is a signal having a phase shifted, by 270 degrees, from the light emission control signal LCLK. In other words, the enable signals EN1 to EN4 are signals having phase differences of 0 degrees, 90 degrees, 180 degrees, and 270 degrees respectively from the light emission control signal LCLK.

### Configuration Example of Pixel

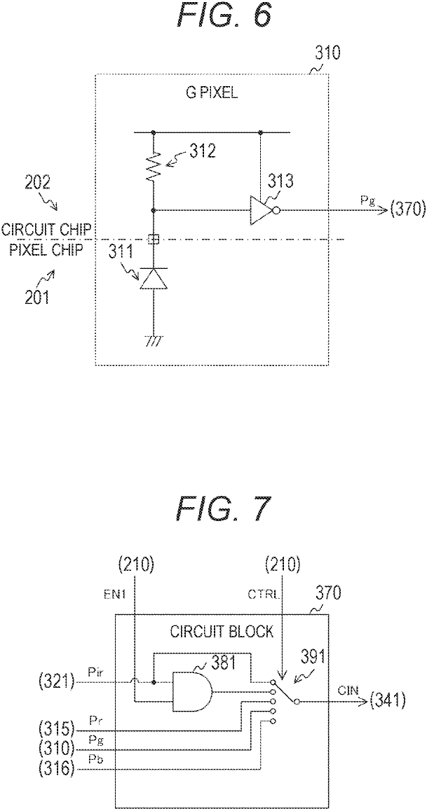

FIG. 6 is a circuit diagram illustrating an example of the configuration of the G pixel 310 according to the first embodiment of the present technology. The G pixel 310 includes a SPAD 311, a resistor 312, and an inverter 313.

The SPAD 311 generates a photocurrent by photoelectric conversion and performs avalanche amplification. The resistor 312 and the SPAD 311 are connected in series between a power supply terminal and a ground terminal.

The inverter 313 inverts the potential at a connection point of the resistor 312 and the SPAD 311 and outputs the inverted potential as the pulse signal Pg to the circuit block 370.

Further, for example, the SPAD 311 is provided on the pixel chip 201, and the resistor 312, the inverter 313, and a circuit (such as the circuit block 370) at a subsequent stage thereof are provided on the circuit chip 202. Incidentally, the entire G pixel 310 can be provided on the pixel chip 201.

The circuit configuration of each of the R pixel 315, the B pixel 316, and the IR pixels 321 to 324 is similar to that of the G pixel 310.

### Configuration Example of Circuit Block

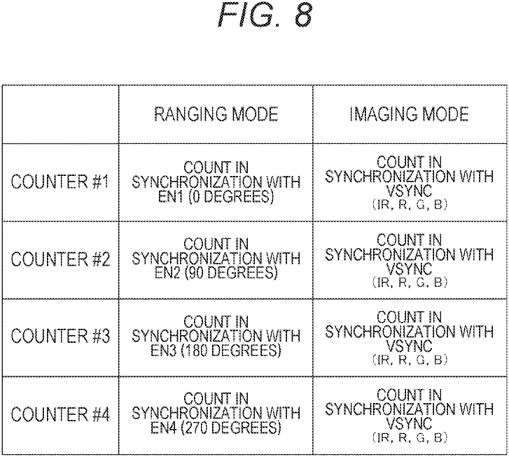

FIG. 7 is a circuit diagram illustrating an example of the configuration of the circuit block 370 according to the first embodiment of the present technology. The circuit block 370 includes an AND (logical product) gate 381 and a selector 391.

The AND (logical product) gate 381 obtains a logical product of the enable signal EN1 from the pixel drive unit 210 and the pulse signal Pir from the IR pixel 321 and outputs the logical product to the selector 391.

The selector 391 selects one of the logical product from the AND gate 381 and the pulse signals Pir, Pr, Pg, and Pb in accordance with the control signal CTRL from the pixel drive unit 210. The selector 391 outputs the selected signal to the counter 341 as the input signal CIN.

### Operation Example of Solid-State Imaging Element

FIG. 8 is an explanatory diagram of the operation of a counter according to the first embodiment of the present technology. The counter 341 in the pixel block 301 is referred to as a counter #1, and a counter in the pixel block 302 is referred to as a counter #2. A counter in the pixel block 303 is referred to as a counter #3, and a counter in the pixel block 304 is referred to as a counter #4.

In the ranging mode, the counter #1 counts the number of pulses (in other words, the number of photons) in synchronization with the enable signal EN1 having a phase difference of 0 degrees. Further, the counter #2 counts the number of pulses in synchronization with the enable signal EN2 having a phase difference of 90 degrees. The counter #3 counts the number of pulses in synchronization with the enable signal EN3 having a phase difference of 180 degrees. The counter #4 counts the number of pulses in synchronization with the enable signal EN3 having a phase difference of 270 degrees.

The signal processing circuit 250 determines a distance by the following formula on the basis of the count values CNT1 to CNT4 of the counters #1 to #4, for example.

$$\begin{matrix}\text{d} \text{=} \left(\text{c} / \text{4} п \text{f}\right) \text{×} {\text{tan}}^{\text{-1}} \\ \times \left\{\left(\text{CNT2} - \text{CNT4}\right) / \left(\text{CNT1} - \text{CNT3}\right)\right\}\end{matrix}$$

In the above formula, “d” represents a distance, and the unit is, for example, meter (m). In the above formula, “c” represents the speed of light, and the unit is, for example, meter per second (m/s). In the above formula, “tan⁻¹” represents an inverse function of the tangent function. The value of (CNT2-CNT4)/(CNT1-CNT3) represents a phase difference between the irradiation light and the reflected light. In the above formula, “n” represents the circular constant. Further, “f” represents a frequency of the irradiation light, and the unit is, for example, megahertz (MHz).

As described above, the distance measurement method for calculating a distance on the basis of flight time of light is called a time of flight (ToF) method. Note that the solid-state imaging element 200 performs distance measurement using four enable signals having different phases; however, the present technology is not limited to the configuration. For example, the solid-state imaging element 200 can perform distance measurement using two enable signals having different phases. In this case, for example, the IR pixel 321 corresponding to 0 degrees and the IR pixel 323 corresponding to 180 degrees are disposed, and the distance is calculated from the count values thereof.

On the other hand, in the imaging mode, the counters #1 to #4 sequentially count the number of pulses of each of the IR pixel, the R pixel, the G pixel, and the B pixel in synchronization with the vertical synchronization signal VSYNC. The signal processing circuit 250 processes the count value of each pixel as a pixel signal of that pixel.

Here, it is assumed that an IR cut filter that blocks infrared light is not provided in each of the R pixel, the G pixel, and the B pixel. In the configuration, the R pixel, the G pixel, and the B pixel receive not only visible light but also infrared light. Thus, the signal processing circuit 250 uses the count value of the IR pixel to separate an IR component from the pixel signal (that is, the count value) of each of the R pixel, the G pixel, and the B pixel, and generates image data.

Note that the IR cut filter may be provided in each of the R pixel, the G pixel, and the B pixel. In this case, separation of the IR component is unnecessary in the imaging mode.

Further, the solid-state imaging element 200 can also capture, in the imaging mode, an IR image in which only pixel signals of the IR pixels are arranged. In this case, for example, the imaging mode includes an IR imaging mode for capturing the IR image, and an RGB imaging mode for capturing an RGB image in which only pixel signals of the R pixels, the G pixels, and the B pixels are arranged. Then, in response to the IR imaging mode set, the counters #1 to #4 output pixel signals of the IR pixels, and in response to the RGB imaging mode set, the counters #1 to #4 output pixel signals of the R, G, and B pixels.

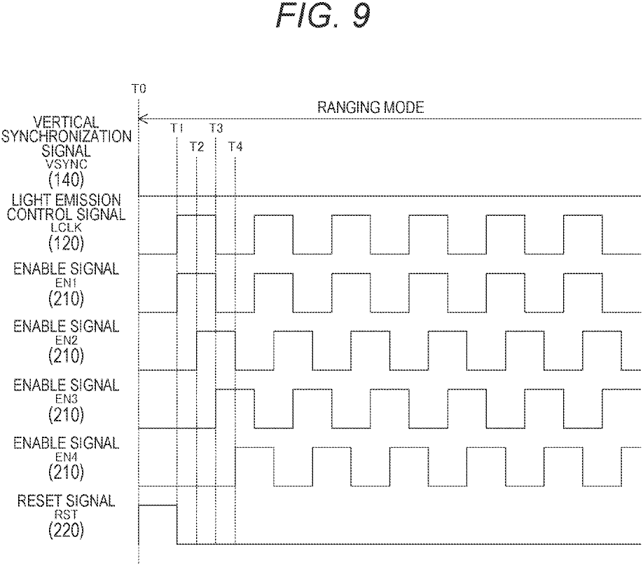

FIG. 9 is a timing chart illustrating an example of the operation in the ranging mode of the solid-state imaging element 200 according to the first embodiment of the present technology. It is assumed that the ranging mode is set at timing T0. The processor 140 stops suppling the vertical synchronization signal VSYNC. The vertical scanning circuit 220 supplies the reset signal RST to each pixel block to initialize the count value.

Further, at timing T1, the driver 120 starts supplying the light emission control signal LCLK, and the light emitting unit 110 emits light in synchronization with the signal. Further, at the timing T1, the pixel drive unit 210 starts suppling the enable signal EN1 having a phase difference of 0 degrees from the light emission control signal LCLK. Then, at timing T2, the pixel drive unit 210 starts supplying the enable signal EN2 having a phase difference of 90 degrees. At timing T3, the pixel drive unit 210 starts supplying the enable signal EN3 having a phase difference of 180 degrees. At timing T4, the pixel drive unit 210 starts supplying the enable signal EN4 having a phase difference of 270 degrees.

Then, after a certain period of time, the vertical scanning circuit 220 outputs the count value by the selection signal SEL. The signal processing circuit 250 calculates a distance for each pixel block using Formula 1 on the basis of the count values.

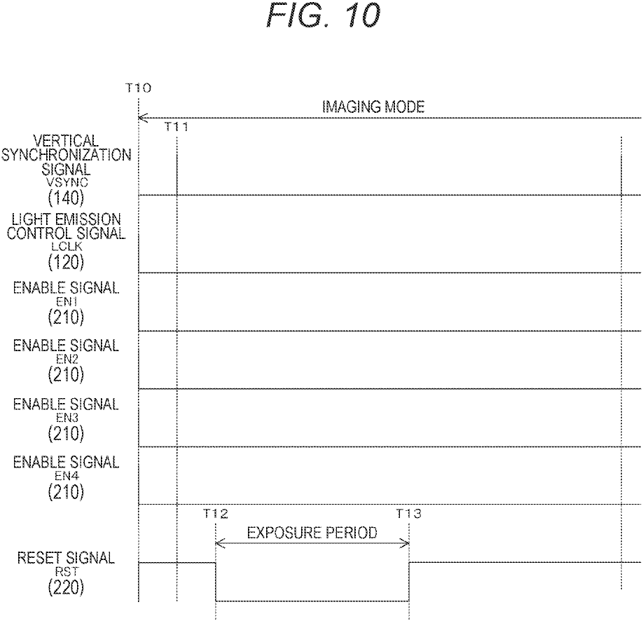

FIG. 10 is a timing chart illustrating an example of the operation of the imaging mode of the solid-state imaging element 200 according to the first embodiment of the present technology. It is assumed that the imaging mode is set at timing T10. The processor 140 starts suppling the vertical synchronization signal VSYNC after timing T11.

Further, the driver 120 stops suppling the light emission control signal LCLK, and the pixel drive unit 210 stops suppling the enable signals EN1 to EN4. The vertical scanning circuit 220 supplies the reset signal RST to each pixel block to initialize the count value. Then, in an exposure period from timing T12 to timing T13 synchronized with the vertical synchronization signal VSYNC, the vertical scanning circuit 220 stops supplying the reset signal RST. During the period, each counter such as the counter 341 counts the number of pulses, and the vertical scanning circuit 220 outputs the count value by the selection signal SEL. The signal processing circuit 250 performs processing such as IR separation on the count values to generate image data.

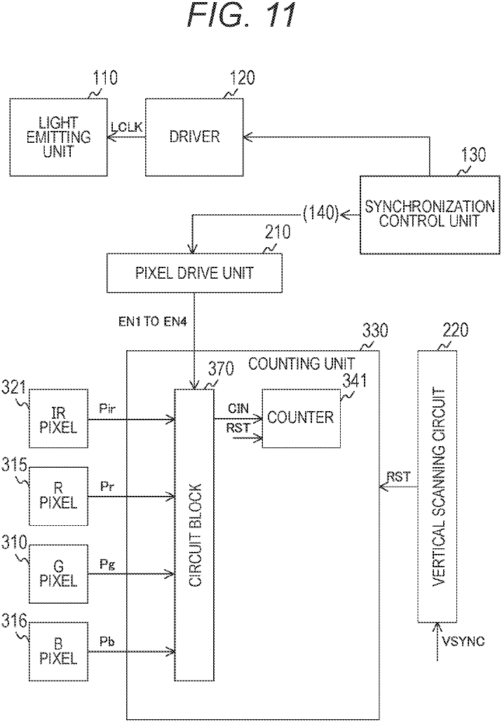

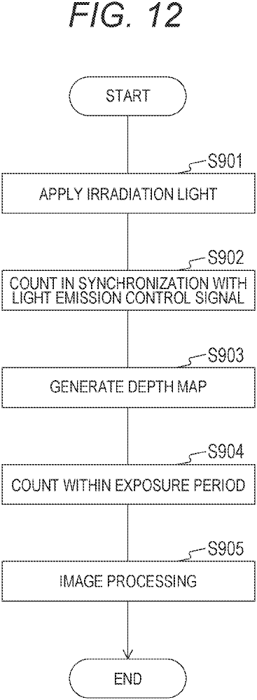

FIG. 11 is an example of an overall view of the sensing system 100 according to the first embodiment of the present technology. In the pixel block 301, the circuit block 370 and the counter 341 are disposed in the counting unit 330.

The light emitting unit 110 applies, as the irradiation light, invisible light (infrared light or the like) in synchronization with the light emission control signal LCLK having a frequency higher than that of the vertical synchronization signal VSYNC. The IR pixel 321 photoelectrically converts reflected light with respect to the irradiation light to generate the pulse signal Pir. The R pixel 315, the G pixel 310, and the B pixel 316 photoelectrically convert red, green, and blue visible light to generate the pulse signals Pr, Pg, and Pb, separately.

Note that the light emitting unit 110 can also apply invisible light (ultraviolet light or the like) other than the infrared light. Further, in the pixel array unit 230, pixels that receive visible light (white or the like) other than red, green, and blue can be arranged.

Further, the IR pixel 321 is an example of an invisible light pixel described in the claims. The R pixel 315, the G pixel 310, and the B pixel 316 are examples of a visible light pixel described in the claims.

The counting unit 330 performs, in the ranging mode, processing for counting the number of pulse signals Pir in synchronization with the enable signal. On the other hand, in the imaging mode, the counting unit 330 performs processing for counting the number of pulse signals Pir, Pr, Pg, and Pb in synchronization with the vertical synchronization signal VSYNC. Since only one counter 341 is provided in the pixel block 301, the counter 341 counts the pulse signals Pir, Pr, Pg, and Pb in a predetermined order.

The control described above allows the solid-state imaging element 200 to not only capture image data but also perform distance measurement using the ToF method. Further, since the solid-state imaging element 200 itself can perform distance measurement, it is not necessary to add a range sensor using infrared rays or lasers. This reduces the power consumption and cost of the sensing system 100 as compared with a case where a range sensor is added separately.

FIG. 12 is a flowchart depicting an example of the operation of the sensing system 100 according to the first embodiment of the present technology. The operation is started, for example, when an application for distance measurement and imaging is run.

The sensing system 100 moves to the ranging mode, and the light emitting unit 110 applies irradiation light in synchronization with the light emission control signal LCLK (step S901). Further, the counter 341 counts the number of pulses in synchronization with the light emission control signal LCLK (step S902). Then, the signal processing circuit 250 performs distance measurement on the basis of the count value to generate a depth map (step S903).

Subsequently, the sensing system 100 moves to the imaging mode, and the counter 341 of the solid-state imaging element 200 counts the number of pulses within the exposure period synchronized with the vertical synchronization signal (step S904). The signal processing circuit 250 performs image processing such as face recognition on the basis of image data in which the count values are arranged (step S905). After step S905, the sensing system 100 ends the operation.

Note that the solid-state imaging element 200 performs the imaging (step S904) after the distance measurement (step S903); however, the solid-state imaging element 200 may perform the distance measurement after the imaging. Further, the distance measurement and the imaging can be performed simultaneously.

As described above, according to the first embodiment of the present technology, the counting unit 330 counts the number of pulses of the R, G, and B pixels and counts the number of pulses of the IR pixels in synchronization with the light emission control signal, so that it is possible to perform distance measurement while capturing image data.

### Modification Example

In the first embodiment described above, the four pixels in the pixel block share one counter 341; however, the configuration does not allow the four pixels to perform counting in parallel. The solid-state imaging element 200 according to the modification example to the first embodiment is different from that of the first embodiment in that a counter is placed for each pixel.

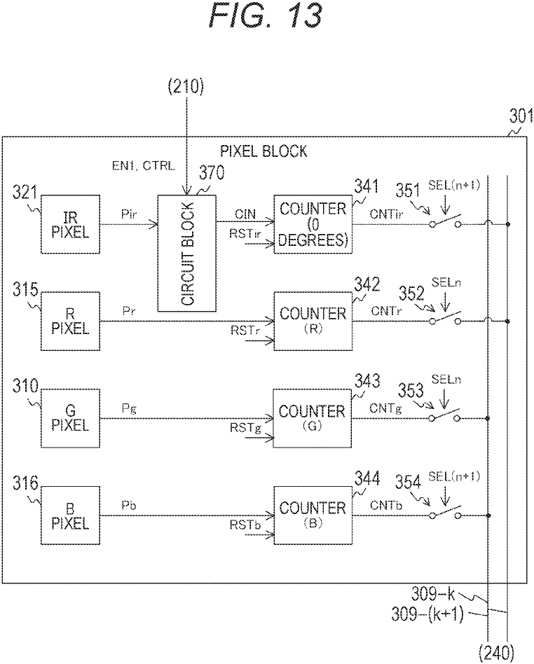

FIG. 13 is a block diagram illustrating an example of the configuration of the pixel block 301 according to the modification example to the first embodiment of the present technology. The pixel block 301 according to the modification example to the first embodiment is different from that of the first embodiment in that the pixel block 301 further includes counters 342, 343, and 344 and switches 352, 353, and 354. The counters 342, 343, and 344 are disposed in the counting unit 330.

The counter 341 according to the first embodiment outputs the count value as a CNTir to the switch 351. The counter 342 counts the number of pulse signals Pr and outputs the count value to the switch 352 as a CNTr. The counters 343 and 344 count the number of pulse signals Pg and Pb, respectively, and output the count values as a CNTg and a CNTb to the switches 353 and 354, respectively. Further, the counters 341, 342, 343, and 344 are initialized by reset signals RSTir, RSTr, RSTg, and RSTb, respectively.

Note that the counters 341 to 344 are examples of first to fourth counters described in the claims.

The switch 351 of the first embodiment outputs the count value CNTir to the column buffer 240 via a vertical signal line 309-(k+1) in accordance with a selection signal SEL(n+1). The switch 352 outputs the count value CNTr to the column buffer 240 via the vertical signal line 309-(k+1) in accordance with a selection signal SELn.

The switch 353 outputs the count value CNTg to the column buffer 240 via a vertical signal line 309-k in accordance with the selection signal SELn. The switch 354 outputs the count value CNTb to the column buffer 240 via the vertical signal line 309-k in accordance with the selection signal SEL(n+1).

Note that the configuration of each of the pixel blocks 302 to 304 is similar to that of the pixel block 301.

FIG. 14 is a circuit diagram illustrating an example of the configuration of the circuit block 370 according to the modification example to the first embodiment of the present technology. The circuit block 370 according to the modification example to the first embodiment is different from that of the first embodiment in that the pulse signals Pr, Pg, and Pb are not inputted to the selector 391. The selector 391 according to the modification example to the first embodiment selects any of the logical product from the AND gate 381 and the pulse signal Pir in accordance with the control signal CTRL.

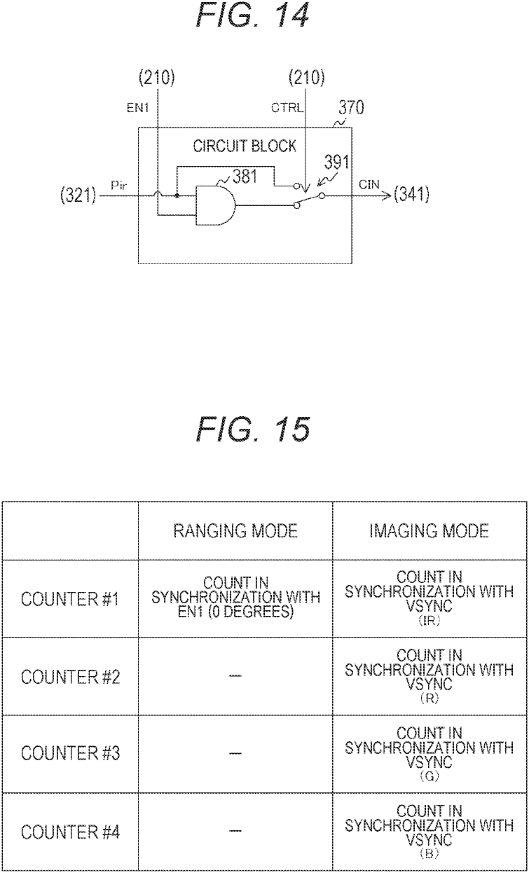

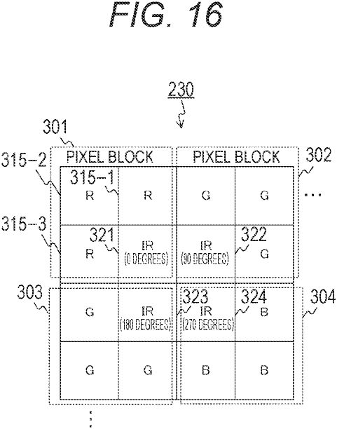

FIG. 15 is an explanatory diagram of the operation of a counter according to the modification example to the first embodiment of the present technology. The counters 341 to 344 are referred to as the counters #1 to #4. In the ranging mode, the counter #1 counts the number of pulses in synchronization with the enable signal EN1 having a phase difference of 0 degrees. The counters #2 to #4 stop the counting operation.

In the imaging mode, the counters #1 to #4 count the number of pulses of each of the IR pixel, the R pixel, the G pixel, and the B pixel in synchronization with the vertical synchronization signal VSYNC. The counting is performed in parallel. As described above, since the counter is provided for each pixel, the four pixels can count the number of pulses in parallel. This enables counting at high speed as compared with a case where the four pixels share one counter.

As described above, in the modification example to the first embodiment of the present technology, since the counters 341 to 344 of the counting unit 330 count the number of pulses in parallel, it is possible to shorten the time required for counting as compared with a case where the four pixels share one counter.

### 2. Second Embodiment

In the first embodiment described above, the four pixels in the pixel block share one counter 341; however, the configuration does not allow each of the visible light pixel and the IR pixel to perform counting in parallel. The solid-state imaging element 200 according to the second embodiment is different from that of the first embodiment in that a counter is placed for each of the visible light pixel and the IR pixel.

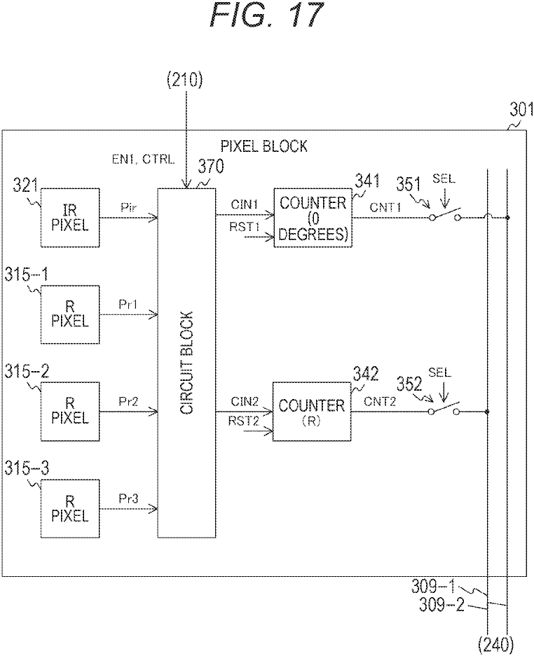

FIG. 16 is an example of a plan view of the pixel array unit 230 according to the second embodiment of the present technology. In the pixel array unit 230 of the second embodiment, the IR pixel 321 and R pixels 315-1, 315-2, and 315-3 are arranged in the pixel block 301. In the pixel block 302, the IR pixel 322 and three G pixels are arranged. In the pixel block 303, the IR pixel 323 and three G pixels are arranged. In the pixel block 304, the IR pixel 324 and three B pixels are arranged.

FIG. 17 is a block diagram illustrating an example of the configuration of the pixel block 301 according to the second embodiment of the present technology. The pixel block 301 according to the second embodiment is different from that of the first embodiment in that the pixel block 301 further includes a counter 342 and a switch 352. The counter 342 and the switch 352 are disposed in the counting unit 330.

The circuit block 370 of the second embodiment outputs an input signal CIN1 to the counter 341 and outputs an input signal CIN2 to the counter 342.

The counter 341 according to the second embodiment counts the number of input signals CIN1 and outputs the count value as the CNT1 to the switch 351. The counter 342 counts the number of input signals CIN2 and outputs the count value as the CNT2 to the switch 352. Note that the counters 341 and 342 are examples of first and second counters described in the claims.

The switch 351 outputs the count value CNT1 to the column buffer 240 via a vertical signal line 309-2 in accordance with the selection signal SEL. The switch 352 outputs the count value CNT2 to the column buffer 240 via a vertical signal line 309-1 in accordance with the selection signal SEL.

Note that the configuration of each of the pixel blocks 302 to 304 is similar to that of the pixel block 301.

FIG. 18 is a circuit diagram illustrating an example of the configuration of the circuit block 370 according to the second embodiment of the present technology. The circuit block 370 according to the second embodiment is different from that of the first embodiment in that the circuit block 370 further includes a selector 392. Further, no pulse signal from the visible light pixel is inputted to the selector 391 of the second embodiment. The selector 391 selects any of the logical product from the AND gate 381 and the pulse signal Pir in accordance with a control signal CTRL1 and outputs the resultant as the input signal CIN1 to the counter 341.

The selector 392 selects any of pulse signals Pr1, Pr2, and Pr3 from the R pixels 315-1, 315-2, and 315-3 in accordance with a control signal CTRL2, and outputs the resultant as the input signal CIN2 to the counter 342. Examples of the selector 392 include, for example, a multiplexer.

As illustrated in FIGS. 16 to 18, since the counter is provided for each of the visible light pixels and the IR pixels, the counting unit 330 can count the number of pulses of the visible light pixels and the number of pulses of the IR pixel 321 in parallel. This enables counting at high speed as compared with a case where the visible light pixels and the IR pixel 321 share one counter.

As described above, according to the second embodiment of the present technology, since the counter 341 counts the number of pulses of the IR pixel and the counter 342 counts the number of pulses of the visible light pixels, it is possible to shorten the time required for counting as compared with a case where these pixels share one counter.

### Modification Example

In the second embodiment described above, the number of pulses of each of the three visible light pixels is counted, and the configuration makes it difficult to shorten the time required for counting. The solid-state imaging element 200 according to the modification example to the second embodiment is different from that of the second embodiment in that pixel addition is performed.

A plan view of the pixel array unit 230 according to the modification example to the second embodiment is similar to that of the second embodiment. Further, in the modification example to the second embodiment, one counter is disposed for each pixel block.

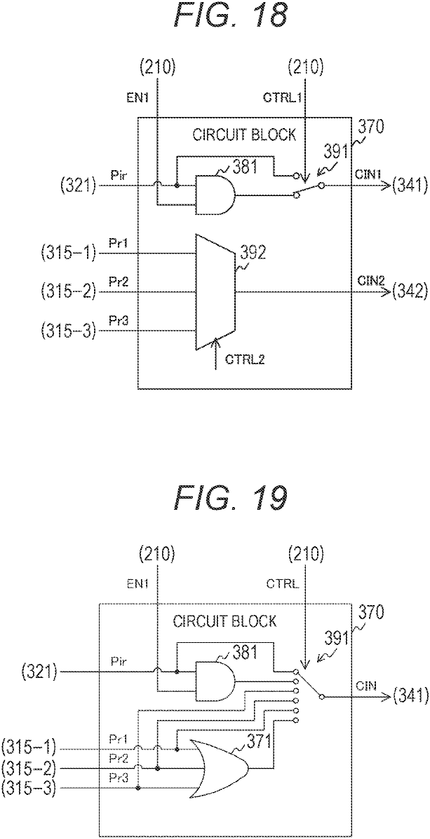

FIG. 19 is a circuit diagram illustrating an example of the configuration of the circuit block 370 according to the modification example to the second embodiment of the present technology. The circuit block 370 according to the modification example to the second embodiment is different from that of the second embodiment in that an OR (logical sum) gate 371 is provided instead of the selector 392.

The OR gate 371 calculates a logical sum of the pulse signals Pr1, Pr2, and Pr3 to output the logical sum to the selector 391. The OR gate 371 can perform pixel addition for the R pixels 315-1, 315-2, and 315-3.

The selector 391 according to the modification example to the second embodiment receives inputs of the logical product from the AND gate 381, the pulse signal Pir, the pulse signals Pr1, Pr2, and Pr3, and the logical sum from the OR gate 371. The selector 391 selects any of the signals in accordance with the control signal CTRL and outputs the resultant to the counter 341 as the input signal CIN.

Further, in the modification example to the second embodiment, the imaging mode includes an addition mode in which pixel addition is performed and a non-addition mode in which no pixel addition is performed. In the addition mode, the selector 391 sequentially selects the logical sum from the OR gate 371 and the pulse signal Pir, and in the non-addition mode, the selector 391 sequentially selects the pulse signals Pir, Pr1, Pr2, and Pr3. The pixel addition enables counting of the number of pulses at high speed.

As described above, according to the modification example to the second embodiment of the present technology, since the selector 391 selects the logical sum from the OR gate 371 in the addition mode, the pixel addition can be performed for three pixels. With this arrangement, the time required for counting the number of pulses can be shortened.

### 3. Third Embodiment

In the first embodiment described above, the IR pixels 321 to 324 are arranged adjacent to each other; however, the arrangement may complicate demosaicing. The solid-state imaging element 200 according to the third embodiment is different from that of the first embodiment in that the IR pixels are arranged at the positions of the G pixels in the Bayer array.

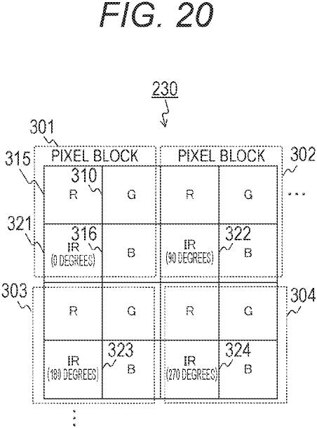

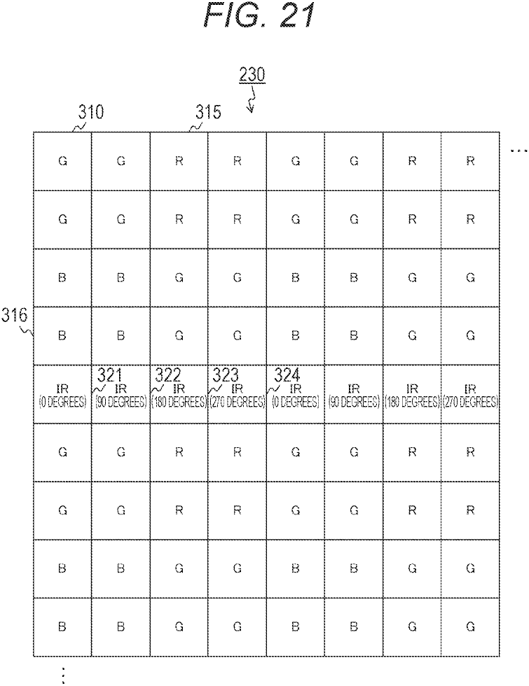

FIG. 20 is an example of a plan view of a pixel array unit according to the third embodiment of the present technology. In the pixel array unit 230 of the third embodiment, the IR pixel 321 is arranged at the lower left or the upper right (lower left in FIG. 20) of the pixel block 301. The IR pixels 322, 323, and 324 are also arranged at the lower left or the upper right (lower left in FIG. 20) of the corresponding pixel block. In other words, the IR pixels are arranged at the positions of the G pixels in the Bayer array. With this arrangement, in a case where a subsequent circuit (the signal processing circuit 250, for example) performs demosaicing, the IR pixels can be interpolated using signals of the G pixels in the same block. This simplifies the demosaicing.

As described above, in the third embodiment of the present technology, since the IR pixels are arranged at the positions of the G pixels in the Bayer array in each pixel block, the demosaicing can be simplified.

### 4. Fourth Embodiment

In the first embodiment described above, the IR pixels 321, 322, 323, and 324 are arranged in a two-dimensional lattice pattern; however, in the array, there is a possibility that the number of IR pixels is insufficient in a predetermined direction (horizontal direction, for example). The solid-state imaging element 200 according to the fourth embodiment is different from that of the first embodiment in that the IR pixels 322, 323, and 324 are arranged only in a predetermined direction.

FIG. 21 is an example of a plan view of the pixel array unit 230 according to the fourth embodiment of the present technology. In the pixel array unit 230 of the fourth embodiment, the individual IR pixels such as the IR pixels 322, 323, and 324 are arranged adjacent to each other in a predetermined direction (horizontal direction). Except for a line in which the IR pixels are arranged, the R, G, and B pixels are arranged in the Bayer array, for example.

As illustrated in FIG. 21, the IR pixels are arranged in a direction such as the horizontal direction, which increases the number of IR pixels in the arrangement direction as compared with a case where the IR pixels are arranged in a two-dimensional lattice pattern. This improves the accuracy of distance measurement in that direction.

Further, in the imaging mode of the fourth embodiment, the counting unit 330 does not count the number of pulses of the IR pixels, and instead, counts only the number of pulses of the R, G, and B pixels. Then, the signal processing circuit 250 interpolates the line in the image data by using pixel signals around the line in which the IR pixels are arranged.

As described above, in the fourth embodiment of the present technology, since the IR pixels 321, 322, 323, and 324 are arranged in the predetermined direction, the number of IR pixels in the arrangement direction is increased as compared with a case where the IR pixels are arranged in a two-dimensional lattice pattern. This improves the accuracy of distance measurement in the direction in which the IR pixels are arranged.

### Modification Example

In the fourth embodiment described above, the IR pixels 321, 322, 323, and 324 are arranged adjacent to each other in the predetermined direction; however, in the configuration, there is a possibility that the number of pixels to be interpolated is increased and the image quality is degraded. The solid-state imaging element 200 according to the modification example to the fourth embodiment is different from that of the fourth embodiment in that the visible light pixel is inserted between the IR pixels.

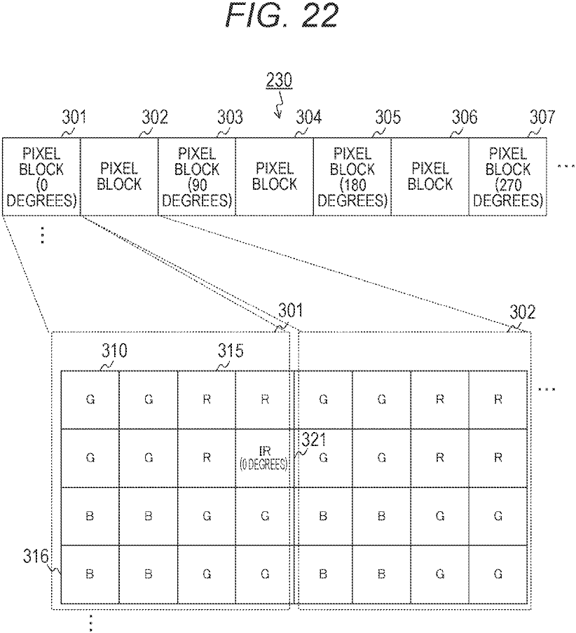

FIG. 22 is an example of a plan view of the pixel array unit 230 according to the modification example to the fourth embodiment of the present technology. The pixel array unit 230 according to the modification example to the fourth embodiment is divided into a plurality of pixel blocks including pixel blocks 301 to 307.

The pixel blocks 301 to 307 are arranged in a predetermined direction (horizontal direction, for example). The pixel block 301 has sixteen pixels arranged in four rows by four columns. Among them, G pixels are arranged in the upper left two rows by two columns and the lower right two rows by two columns. In the upper right two rows by two columns, three R pixels and an IR pixel are arranged. Further, the IR pixel is arranged at the lower right of the four pixels. In the lower left two rows by two columns, B pixels are arranged.

The pixel block 302 has sixteen pixels arranged in four rows by four columns. Among them, G pixels are arranged in the upper left two rows by two columns and the lower right two rows by two columns. In the upper right two rows by two columns, R pixels are arranged, and in the lower left two rows by two columns, B pixels are arranged. Such an array is called the Quadra array. In the Quadra array, the signal processing circuit 250 can improve the sensitivity by performing pixel addition of four adjacent visible light pixels in a dark place or the like.

The array of each of the pixel blocks 303, 305, and 307 is similar to that of the pixel block 301. The array of each of the pixel blocks 304 and 306 is similar to that of the pixel block 302.

Further, the number of pulses of the IR pixel of the pixel block 301 is counted in synchronization with the enable signal EN1 having a phase difference of 0 degrees, and the number of pulses of the IR pixel of the pixel block 303 is counted in synchronization with the enable signal EN2 having a phase difference of 90 degrees. The number of pulses of the IR pixel of the pixel block 305 is counted in synchronization with the enable signal EN3 having a phase difference of 180 degrees, and the number of pulses of the IR pixel of the pixel block 307 is counted in synchronization with the enable signal EN4 having a phase difference of 270 degrees.

The visible light pixels are inserted between the IR pixels in the array illustrated in FIG. 22. With this arrangement, the number of pixels to be interpolated in the imaging mode is reduced as compared with a case where the IR pixels are arranged adjacent to each other, and the image quality can be improved.

As described above, in the modification example to the fourth embodiment of the present technology, since the IR pixels are arranged in a predetermined direction and the visible light pixels are inserted therebetween, the number of pixels to be interpolated can be reduced as compared with a case where the IR pixels are arranged adjacent to each other. This improves the image quality of image data.

### 5. Fifth Embodiment

In the first embodiment described above, the R, G, and B pixels and the IR pixels are arranged in the individual pixel blocks 301 to 304; however, in the configuration, the minimum unit of distance measurement is 16 pixels and there is a possibility that the range-finding points are insufficient. The solid-state imaging element 200 according to the fifth embodiment is different from that of the first embodiment in that the number of range-finding points is increased.

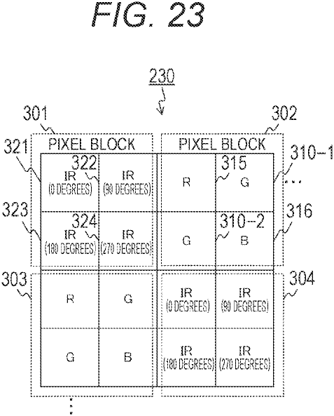

FIG. 23 is an example of a plan view of the pixel array unit 230 according to the fifth embodiment of the present technology. The pixel array unit 230 according to the fifth embodiment is divided into a plurality of pixel blocks including the pixel blocks 301 to 304.

In the upper left pixel block 301, the IR pixels 321 to 324 are arranged in two rows by two columns. In the upper right pixel block 302, the R pixel 315, a G pixel 310-1, a G pixel 310-2, and the B pixel 316 are arranged in the Bayer array. The array of the lower left pixel block 303 is similar to that of the pixel block 302. The array of the lower right pixel block 304 is similar to that of the pixel block 301.

With the arrangement illustrated in FIG. 23, the signal processing circuit 250 at the subsequent stage can determine the distance for two pixel blocks in a region of 16 rows by 16 columns. That is, the number of range-finding points is doubled as compared with the first embodiment.

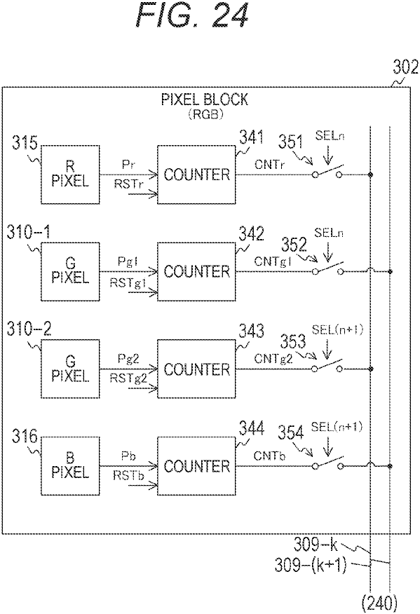

FIG. 24 is a block diagram illustrating an example of the configuration of the pixel block 302 in which visible light pixels are arranged according to the fifth embodiment of the present technology. The pixel block 302 includes the R pixel 315, the G pixel 310-1, the G pixel 310-2, the B pixel 316, the counters 341 to 344, and the switches 351 to 354. The counters 341 to 344 are disposed in the counting unit 330.

The counter 341 of the fifth embodiment counts the number of pulse signals Pr from the R pixel 315 and outputs the count value CNTr to the switch 351. The counter 342 of the fifth embodiment counts the number of pulse signals Pg1 from the G pixel 310-1 and outputs a count value CNTg1 to the switch 352. The counter 343 of the fifth embodiment counts the number of pulse signals Pg2 from the G pixel 310-2 and outputs a count value CNTg2 to the switch 353. The counter 344 of the fifth embodiment counts the number of pulse signals Pb from the B pixel 316 and outputs the count value CNTb to the switch 354.

Further, the counters 341, 342, 343, and 344 are initialized by reset signals RSTr, RSTg1, RSTg2, and RSTb, respectively.

The switch 351 of the fifth embodiment outputs the count value CNTr to the column buffer 240 via the vertical signal line 309-k in accordance with the selection signal SELn. The switch 352 of the fifth embodiment outputs the count value CNTg1 to the column buffer 240 via the vertical signal line 309-(k+1) in accordance with the selection signal SELn. The switch 353 of the fifth embodiment outputs the count value CNTg2 to the column buffer 240 via the vertical signal line 309-k in accordance with the selection signal SEL(n+1). The switch 354 of the fifth embodiment outputs the count value CNTb to the column buffer 240 via the vertical signal line 309-(k+1) in accordance with the selection signal SEL(n+1).

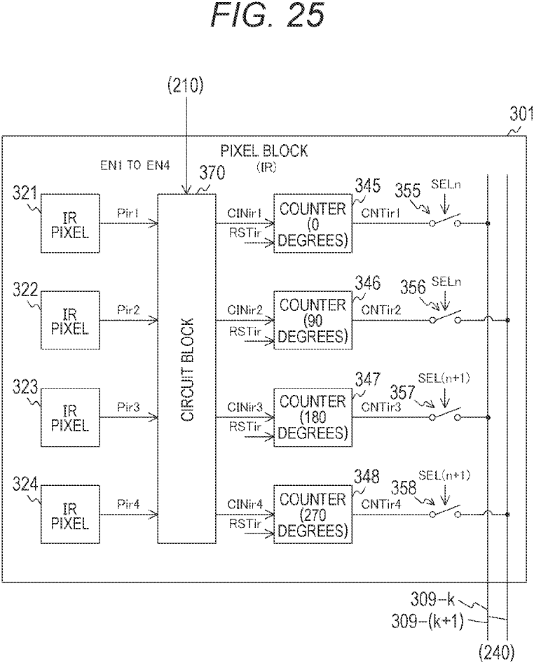

FIG. 25 is a block diagram illustrating an example of the configuration of the pixel block 301 in which IR pixels are arranged according to the fifth embodiment of the present technology. The pixel block 301 includes the IR pixels 321 to 324, the circuit block 370, counters 345 to 348, and switches 355 to 358. The counters 345 to 348 are disposed in the counting unit 330.

The circuit block 370 of the fifth embodiment supplies, in the ranging mode, a logical sum of the pulse signals to the counter 345 as an input signal CINir1 in synchronization with the enable signal EN1 having a phase difference of 0 degrees. Further, in the ranging mode, the circuit block 370 supplies the logical sum of the pulse signals as input signals CINir2 to CINir4 to the counters 346 to 348, respectively in synchronization with the enable signals EN2 to EN4 having phase differences of 90 degrees, 180 degrees, and 270 degrees, respectively.

The counters 345 to 348 count the number of input signals CINir1 to CINir4, respectively. The counters output the count values as CNTir1 to CNTir4 to the switches 355 to 358, respectively.

The configurations of the switches 355 to 358 are similar to those of the switches 351 to 354 respectively in the pixel block 302 in which the visible light pixels are arranged.

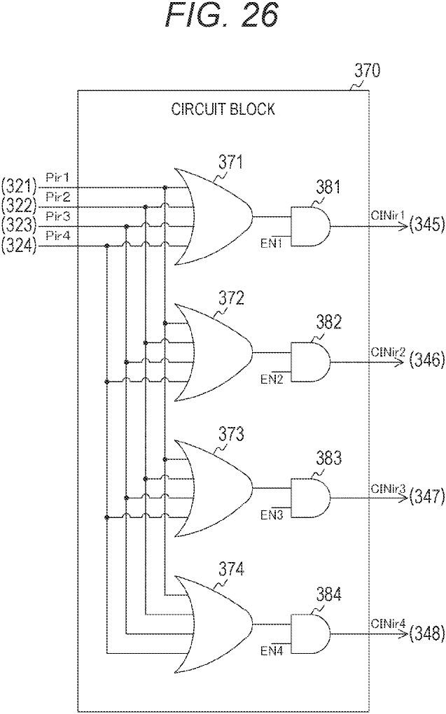

FIG. 26 is a circuit diagram illustrating an example of the configuration of the circuit block 370 according to the fifth embodiment of the present technology. The circuit block 370 of the fifth embodiment includes OR gates 371 to 374 and AND gates 381 to 384.

The OR gate 371 of the fifth embodiment outputs a logical sum of pulse signals Pin1 to Pin4 to the AND gate 381. The OR gates 372 to 374 output a logical sum of the pulse signals Pin1 to Pin4 to the AND gates 382 to 384.

The AND gate 381 of the fifth embodiment calculates a logical product of the enable signal EN1 and the output of the OR gate 371, and outputs the logical product as the input signal CINir1 to the counter 345. The AND gates 382 to 384 calculate a logical product of the enable signals EN2 to EN4 and the outputs of the OR gates 372 to 374 respectively, and output the logical products as the input signals CINir2 to CINir4 to the counters 346 to 348 respectively.

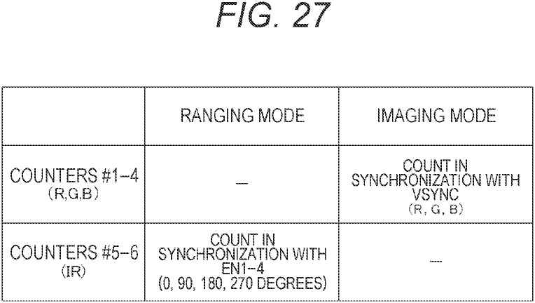

FIG. 27 is an explanatory diagram of the operation of a counter according to the fifth embodiment of the present technology. The counters 341 to 344 of the pixel block 302 in which R, G, and B pixels are arranged are referred to as the counters #1 to #4, respectively, and the counters 345 to 348 of the pixel block 301 in which IR pixels are arranged are referred to as counters #5 to #8, respectively.

In the ranging mode, the counters #5 to #8 count the number of pulses in synchronization with the enable signals EN1 to EN4 having phase differences of 0 degrees, 90 degrees, 180 degrees, and 270 degrees, respectively. The counters #1 to #4 stop the counting operation.

On the other hand, in the imaging mode, the counters #1 to #4 count the number of pulses of each of the R pixel 315, the G pixel 310-1, the G pixel 310-2, and the B pixel 316 in synchronization with the vertical synchronization signal VSYNC. The counters #5 to #8 stop the counting operation.

As illustrated in FIGS. 24 to 27, since the counter is provided for each pixel, counting can be performed at high speed as compared with the first embodiment in which the four pixels share one counter.

As described above, according to the fifth embodiment of the present technology, the signal processing circuit 250 calculates a distance for two pixel blocks in the region of 16 rows by 16 columns, and thus, the number of range-finding points can be increased. Further, since the counter is provided for each pixel, the time required for counting can be shortened as compared with a case where the four pixels share one counter.

### First Modification Example

In the fifth embodiment described above, the counter is provided for each pixel; however, the configuration makes it difficult to miniaturize the pixels. The solid-state imaging element 200 according to the first modification example to the fifth embodiment is different from that of the fifth embodiment in that a plurality of visible light pixels shares a counter.

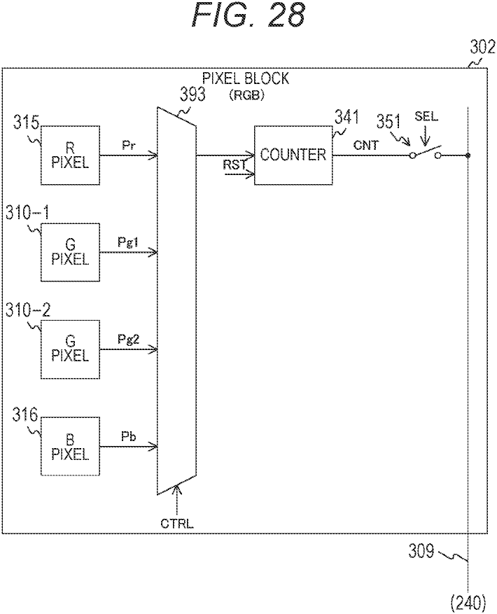

FIG. 28 is a block diagram illustrating an example of the configuration of the pixel block 302 in which visible light pixels are arranged according to the first modification example to the fifth embodiment of the present technology. The pixel block 302 according to the first modification example to the fifth embodiment is different from that of the fifth embodiment in that the pixel block 302 does not include the selectors 342 to 344 and the switches 352 to 354. Further, the pixel block 302 further includes a selector 393.

The selector 393 selects any of the pulse signals Pr, Pg1, Pg2, and Pb in accordance with the control signal CTRL, and outputs the resultant to the counter 341. Further, the counter 341 according to the modification example to the fifth embodiment outputs the count value as the CNT to the switch 351.

As illustrated in FIG. 28, since the selector 393 selects any of the pulse signals of the four pixels, the four pixels can share the counter 341. Reducing the number of counters makes it easy to increase the number of pixels.

As described above, according to the first modification example to the fifth embodiment of the present technology, since the selector 393 selects any of the pulse signals of the four pixels, the four pixels can share one counter 341. This facilitates the increase in the number of pixels.

### Second Modification Example

In the fifth embodiment described above, the distance is calculated using the enable signals EN1 to EN4 having a fixed phase in the pixel block 301 in which the IR pixels are arranged; however, in this configuration, the range-finding points may be insufficient. The solid-state imaging element 200 according to the second modification example to the fifth embodiment is different from that of the fifth embodiment in that a phase of an enable signal is switched to increase the number of range-finding points.

FIG. 29 is a block diagram illustrating an example of the configuration of the pixel block 301 in which IR pixels are arranged according to the second modification example to the fifth embodiment of the present technology. In the second modification example to the fifth embodiment, the counters 345 and 348 count the number of pulses in synchronization with an enable signal for switching the phase difference from 0 degrees to 180 degrees. The counters 346 and 347 count the number of pulses in synchronization with an enable signal for switching the phase difference from 90 degrees to 270 degrees.

Note that the counters 345 and 348 are examples of a first counter described in the claims, and the counters 346 and 347 are examples of a second counter described in the claims.

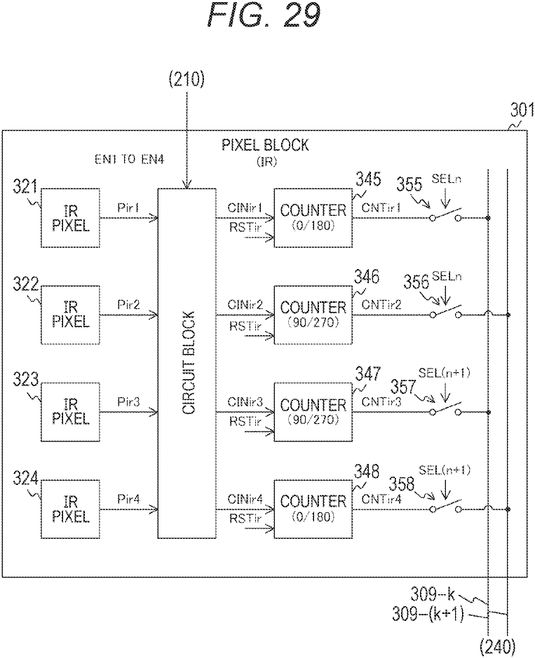

FIG. 30 is a timing chart illustrating an example of the operation of the ranging mode of the solid-state imaging element 200 according to the second modification example to the fifth embodiment of the present technology. It is assumed that the ranging mode is set at timing T0. The processor 140 stops suppling the vertical synchronization signal VSYNC. The vertical scanning circuit 220 supplies the reset signal RSTir to the counters 345 to 348 to initialize the count values.

Further, at timing T1, the driver 120 starts supplying the light emission control signal LCLK, and the light emitting unit 110 emits light in synchronization with the signal. Further, at the timing T1, the pixel drive unit 210 starts suppling the enable signals EN1 and EN4 having a phase difference of 0 degrees from the light emission control signal LCLK. Then, at the timing T2, the pixel drive unit 210 starts supplying the enable signals EN2 and EN3 having a phase difference of 90 degrees.

Then, after a certain period of time, the vertical scanning circuit 220 outputs the count value by a selection signal. The signal processing circuit 250 keeps these count values.

Then, at the timing T3, the vertical scanning circuit 220 supplies the reset signal RSTir to the counters 345 to 348 to initialize the count values. At the timing T4, the pixel drive unit 210 starts suppling the enable signals EN1 and EN4 having a phase difference of 180 degrees from the light emission control signal LCLK. Then, at timing T5, the pixel drive unit 210 starts supplying the enable signals EN2 and EN3 having a phase difference of 270 degrees.

Then, after a certain period of time, the vertical scanning circuit 220 outputs the count value by a selection signal. The signal processing circuit 250 calculates a distance for each pixel block on the basis of the count values kept and the count values outputted.

As illustrated in FIG. 30, the pixel drive unit 210 supplies an enable signal in which each of a plurality of set values (90 degrees, 270 degrees, and the like) is sequentially set to a phase difference. The phase difference is switched in this manner, which enables two range-finding points to be provided in the pixel block 301, and the number of range-finding points can be doubled as compared with the fifth embodiment.

As described above, according to the second modification example to the fifth embodiment of the present technology, since the pixel drive unit 210 switches the phase difference of the enable signal, it is possible to increase the number of range-finding points.

### Third Modification Example

In the fifth embodiment described above, the counter counts the number of pulses in units of four pixels in the ranging mode. However, in this configuration, as the number of pixels to be counted increases, the maximum value of the count values increases, which increases the data size of the count values. The solid-state imaging element 200 according to the third modification example to the fifth embodiment is different from that of the fifth embodiment in that the number of pixels to be counted is switched between four pixels and two pixels, and the data size is made variable.

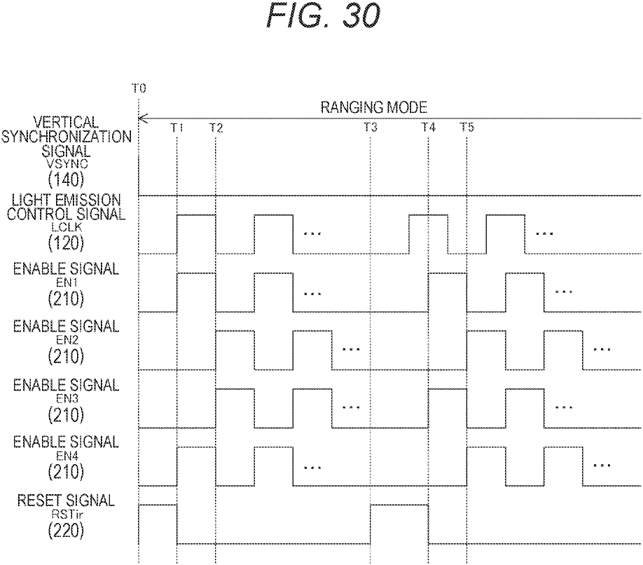

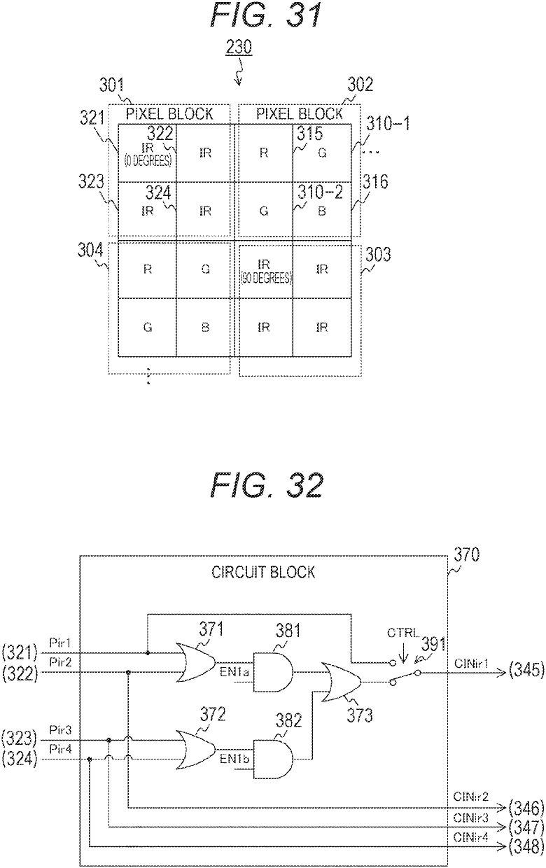

FIG. 31 is an example of a plan view of a pixel array unit according to the third modification example to the fifth embodiment of the present technology. In the third modification example to the fifth embodiment, the number of pulses is counted in synchronization with the enable signal EN1 of 0 degrees in the pixel block 301. Further, in the pixel block 303, the number of pulses is counted in synchronization with the enable signal EN2 of 90 degrees. Further, in each of the other two pixel blocks, the number of pulses is counted in synchronization with the enable signals EN2 of 180 degrees and 270 degrees. In FIG. 31, a pixel block corresponding to 180 degrees and a pixel block corresponding to 270 degrees are omitted.

FIG. 32 is a circuit diagram illustrating an example of the configuration of the circuit block 370 according to the third modification example to the fifth embodiment of the present technology. The circuit block 370 according to the third modification example to the fifth embodiment is different from that of the fifth embodiment in that the circuit block 370 does not include the OR gate 374 and the AND gates 383 and 384 and further includes the selector 391.

The OR gate 371 according to the third modification example to the fifth embodiment outputs a logical sum of pulse signals Pir1 and Pir2 to the AND gate 381. The OR gate 372 according to the third modification example to the fifth embodiment outputs a logical sum of pulse signals Pir3 and Pir4 to the AND gate 382.

The AND gate 381 according to the third modification example to the fifth embodiment outputs a logical product of a signal from the OR gate 371 and an enable signal EN1a to an OR gate 373. The AND gate 382 according to the third modification example to the fifth embodiment outputs a logical product of a signal from the OR gate 372 and an enable signal EN1b to the OR gate 373.

The OR gate 373 according to the third modification example to the fifth embodiment outputs the logical sum of the signals from each of the AND gates 381 and 382 to the selector 391.

The selector 391 according to the third modification example to the fifth embodiment selects any of the pulse signal Pir1 and a signal from the OR gate 373 in accordance with the control signal CTRL and outputs the resultant to the counter 345 as the input signal CINir1.

Further, the pulse signals Pir2 to Pir4 are directly supplied to the counters 346 to 348 as input signals CINir2 to CINir4, respectively.

A logical circuit including the OR gates 371 to 373 and the AND gates 381 and 382 illustrated in FIG. 32 outputs a logical sum of two or more of the pulse signals of the four pixels.

Note that the counters 345 to 348 are examples of fifth to eighth counters described in the claims.

FIG. 33 is an explanatory diagram of the operation of the pixel drive unit 210 according to the third modification example to the fifth embodiment of the present technology. The control in FIG. 33 corresponds to the pixel block 301. In the third modification example to the fifth embodiment, either a four-pixel addition mode or a two-pixel addition mode is set in the ranging mode. The four-pixel addition mode is a mode in which the number of pixels to be counted in the pulse signal is four pixels, and the two-pixel addition mode is a mode in which the number of pixels to be counted in the pulse signal is two pixels.

In the four-pixel addition mode, the pixel drive unit 210 supplies a signal having a phase difference of 0 degrees as the enable signals ENla and EN1b. In the two-pixel addition mode, the pixel drive unit 210 supplies a signal having a phase difference of 0 degrees as one of the enable signals ENla and EN1b. The other of the enable signals EN1a and ENlb is not supplied. Further, in the imaging mode, no enable signal is supplied. Note that control of blocks other than the pixel block 301 is similar to that of the pixel block 301 illustrated in FIG. 33 except that the phase difference is set to 90 degrees or the like.

Further, in the ranging mode, the pixel drive unit 210 sets the control signal CTRL to “0 ” and causes the selector 391 to select a signal from the OR gate 373. On the other hand, in the imaging mode, the pixel drive unit 210 sets the control signal CTRL to “1 ” and causes the selector 391 to select the pulse signal Pir1.

With the configuration illustrated in FIGS. 32 and 33, the circuit block 370 outputs the logical sum of the pulse signals of the set number (four pixels or two pixels) of pixels among the four pixels in the pixel block 301, and the counter 345 counts a logical sum thereof. With this arrangement, the number of pixels to be counted can be switched between four pixels and two pixels, and the data size of the count value can be changed.

Note that the pixel drive unit 210 switches the number of pixels to be counted between four pixels and two pixels; however, the present technology is not limited to the configuration, and for example, the number of pixels to be counted can be switched between one pixel, three pixels, or the like.

As described above, according to the third modification example to the fifth embodiment of the present technology, since the counter 345 counts the logical sum of the pulse signals of the set number of pixels among the four pixels in the pixel block 301, the data size of the count value can be changed.

### Fourth Modification Example

In the third modification example to the fifth embodiment described above, counting is performed in synchronization with the enable signal EN1 of 0 degrees in the pixel block 301; however, in this configuration, four pixel blocks are required to obtain one range-finding point and there is a possibility that the range-finding points are insufficient. The solid-state imaging element 200 according to the fourth modification example to the fifth embodiment is different from that of the third modification example to the fifth embodiment in that a phase difference between enable signals is switched.

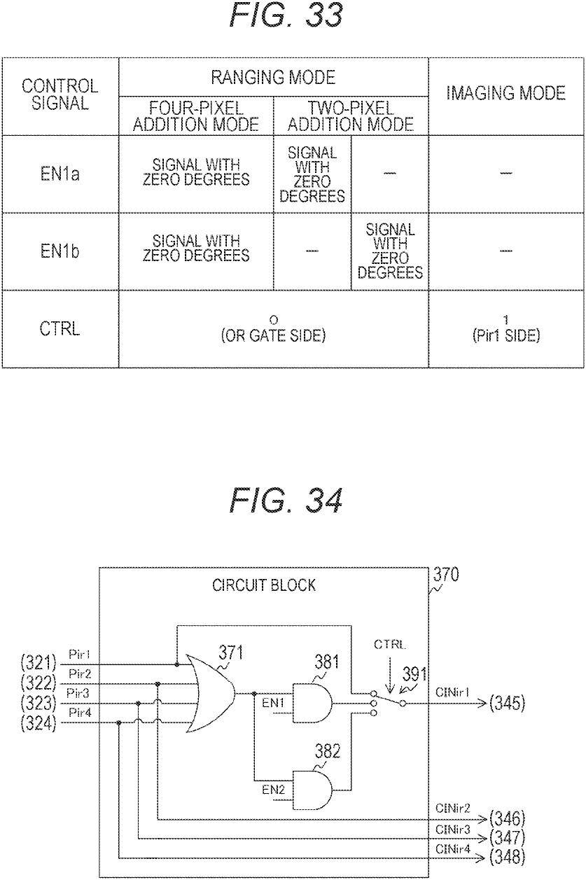

FIG. 34 is a circuit diagram illustrating an example of the configuration of the circuit block 370 according to the fourth modification example to the fifth embodiment of the present technology. The circuit block 370 according to the fourth modification example to the fifth embodiment is different from that of the third modification example to the fifth embodiment in that the circuit block 370 does not include the OR gates 372 to 374 and the AND gates 383 and 384. Further, the pixel block 370 further includes the selector 391.

The OR gate 371 according to the fourth modification example to the fifth embodiment outputs a logical sum of the pulse signals Pir1 to Pir4 to the AND gates 381 and 382.

The AND gate 381 according to the fourth modification example to the fifth embodiment outputs a logical product of a signal from the OR gate 371 and the enable signal EN1 to the selector 391. The AND gate 382 according to the fourth modification example to the fifth embodiment outputs a logical product of a signal from the OR gate 371 and the enable signal EN2 to the selector 391. Further, the phase difference of the enable signal EN1 is switched from 0 degrees to 180 degrees. The phase difference of the enable signal EN2 is switched from 90 degrees to 270 degrees.

The selector 391 according to the fourth modification example to the fifth embodiment selects any of the pulse signal Pir1, a signal from the AND gate 381, and a signal from the AND gate 382 in accordance with the control signal CTRL and outputs the resultant to the counter 345 as the input signal CINir1.

A logical circuit including the OR gate 371 and the AND gates 381 and 382 illustrated in FIG. 34 outputs a logical product of a logical sum of pulse signals of the individual four pixels and the enable signals EN1 and EN2.

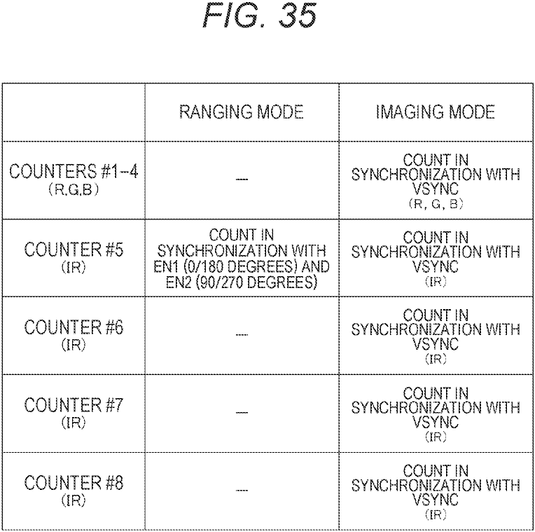

FIG. 35 is an explanatory diagram of the operation of a counter according to the fourth modification example to the fifth embodiment of the present technology. The counters 341 to 344 of the pixel block 302 in which R, G, and B pixels are arranged are referred to as the counters #1 to #4, respectively, and the counters 345 to 348 of the pixel block 301 in which IR pixels are arranged are referred to as counters #5 to #8, respectively.

In the ranging mode, the counter #5 counts the number of pulses in synchronization with the enable signal EN1 having a phase difference of 0 degrees or 180 degrees, and then counts the number of pulses in synchronization with the enable signal EN2 having a phase difference of 90 degrees or 270 degrees. The counters other than the counter #5 stop the counting operation.

On the other hand, in the imaging mode, the counters #1 to #4 sequentially count the number of pulses of each of the R pixel, the G pixel, and the B pixel in synchronization with the vertical synchronization signal VSYNC. Further, the counters #5 to #8 count the number of pulses of each of the IR pixels 321 to 324.

Note that it is also possible to use two imaging modes separately: an IR imaging mode for capturing an IR image; and an imaging mode for capturing an RGB image in which R, G, and B pixels are arranged. In this case, it is only required that, in capturing an IR image, only the counters #5 to #8 count the number of pulses, and, in capturing an RGB image, only the counters #1 to #4 count the number of pulses.

As illustrated in FIG. 35, since the counter #5 (counter 345) counts the number of pulses in synchronization with the enable signals of 0 degrees, 90 degrees, 180 degrees, and 270 degrees, the signal processing circuit 250 can measure the distance for each pixel block in which the IR pixels are arranged. With this arrangement, it is possible to increase the number of range-finding points as compared with the third modification example to the fifth embodiment in which four pixel blocks are necessary in order to obtain one range-finding point.

As described above, according to the fourth modification example to the fifth embodiment of the present technology, since the counter 345 counts the number of pulses in synchronization with the enable signals of 0 degrees, 90 degrees, 180 degrees, and 270 degrees, the distance can be measured for each pixel block.

### Fifth Modification Example

In the fifth embodiment described above, the counter is provided for each pixel; however, the configuration makes it difficult to miniaturize the pixels. The solid-state imaging element 200 according to the fifth modification example to the fifth embodiment is different from that of the fifth embodiment in that a phase difference between enable signals is switched to reduce the number of counters.

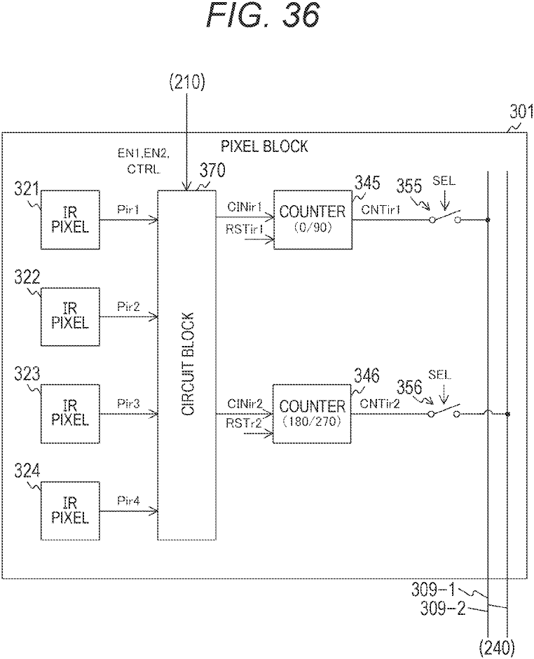

FIG. 36 is a block diagram illustrating an example of the configuration of the pixel block 301 in which IR pixels are arranged according to a fifth modification example to the fifth embodiment of the present technology. The pixel block 301 according to the fifth embodiment is different from that of the fifth embodiment in that the pixel block 301 does not include the counters 347 and 348 and the switches 357 and 358.

FIG. 37 is a circuit diagram illustrating an example of the configuration of the circuit block 370 according to the fifth modification example to the fifth embodiment of the present technology. The circuit block 370 according to the fifth modification example to the fifth embodiment is different from that of the fifth embodiment in that the circuit block 370 does not include the OR gates 372 and 374 and the AND gates 383 and 384 and further includes the selector 391 and a switch 395.

The OR gate 371 according to the fifth modification example to the fifth embodiment outputs a logical sum of the pulse signals Pir1 to Pir4 to the AND gates 381 and 382.

The AND gate 381 according to the fifth modification example to the fifth embodiment outputs a logical product of a signal from the OR gate 371 and the enable signal EN1 to the selector 391. The AND gate 382 according to the fifth modification example to the fifth embodiment outputs a logical product of a signal from the OR gate 371 and the enable signal EN2 to the switch 395. Further, the phase difference of the enable signal EN1 is switched from 0 degrees to 180 degrees. The phase difference of the enable signal EN2 is switched from 90 degrees to 270 degrees.

A logical circuit including the OR gate 371 and the AND gates 381 and 382 described above outputs a logical product of a logical sum of a pulse signal of each of the four pixels and the enable signals EN1 and EN2.

The selector 391 according to the fifth modification example to the fifth embodiment selects any of the pulse signal Pir1 and a signal from the AND gate 381 in accordance with the control signal CTRL1 and outputs the resultant to the counter 345 as the input signal CINir1.

The switch 395 outputs a signal from the AND gate 382 to the counter 346 as the input signal CINir2 in accordance with the control signal CTRL2.

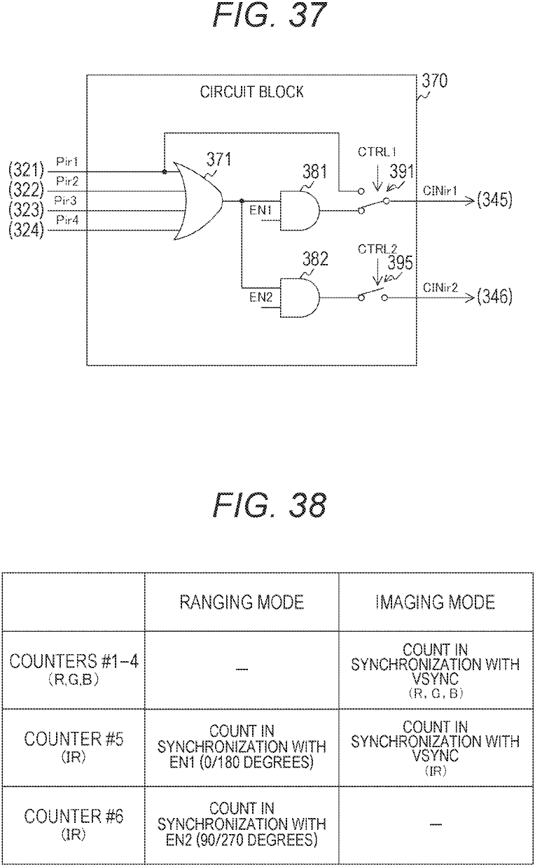

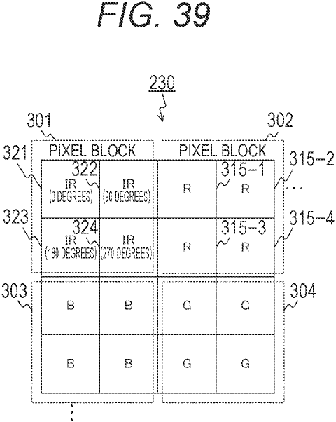

FIG. 38 is an explanatory diagram of the operation of a counter according to the fifth modification example to the fifth embodiment of the present technology. The counters 341 to 344 of the pixel block 302 in which R, G, and B pixels are arranged are referred to as the counters #1 to #4, respectively, and the counters 345 and 346 of the pixel block 301 in which IR pixels are arranged are referred to as the counters #5 and #6, respectively.

In the ranging mode, the counter #5 counts the number of pulses in synchronization with the enable signal EN1 having a phase difference of 0 degrees or 180 degrees, and the counter #6 counts the number of pulses in synchronization with the enable signal EN2 having a phase difference of 90 degrees or 270 degrees. The counters #1 to #4 stop the counting operation.

On the other hand, in the imaging mode, the counters #1 to #4 count the number of pulses of each of the R pixel 315, the G pixel 310-1, the G pixel 310-2, and the B pixel 316 in synchronization with the vertical synchronization signal VSYNC. The counter #5 counts the number of pulses of the IR pixel 321. The counter #6 stops the counting operation.

As illustrated in FIGS. 36 to 38, since the pixel drive unit 210 switches the phase difference between the enable signals EN1 and EN2, the number of counters of the pixel block 301 can be reduced to two.

Note that it is also possible to use two imaging modes separately: an IR imaging mode for capturing an IR image; and an imaging mode for capturing an RGB image. In this case, it is only required that, in capturing an IR image, only the counter #5 counts the number of pulses, and, in capturing an RGB image, only the counters #1 to #4 count the number of pulses.

As described above, according to the fifth modification example to the fifth embodiment of the present technology, since the pixel drive unit 210 switches the phase difference between the enable signals EN1 and EN2, the number of counters of the pixel block 301 can be reduced to the two counters 345 and 346.

### 6. Sixth Embodiment

In the first embodiment described above, the visible light pixels are arranged in the Bayer array; however, a visible light pixel that receives a pair of incident light subjected to pupil division may be provided, and a pixel signal may be used for phase difference auto focus (AF). The solid-state imaging element 200 according to the sixth embodiment is different from that of the fifth embodiment in that a visible light pixel receives a pair of incident light subjected to pupil division.

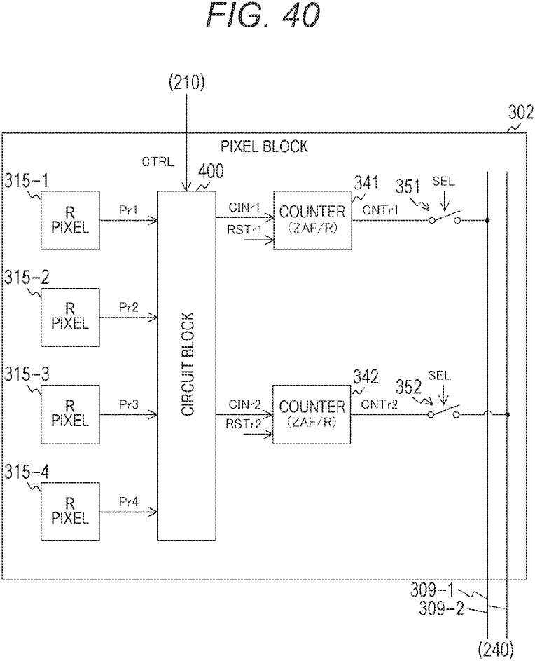

FIG. 39 is an example of a plan view of the pixel array unit 230 according to the sixth embodiment of the present technology. In the pixel array unit 230 of the sixth embodiment, the R pixels 315-1 to 315-4 are arranged in two rows by two columns in the upper right pixel block 302. In the lower left pixel block 303, four B pixels are arranged in two rows by two columns. In the lower right pixel block 304, four G pixels are arranged in two rows by two columns. The array illustrated in FIG. 39 corresponds to the Quadra array except that four G pixels are replaced with the IR pixels 321 to 324.

Further, the R pixels 315-1 and 315-2 receive one of a pair of incident light subjected to pupil division, and the R pixels 315-3 and 315-4 receive the other of the pair of incident light. A subsequent circuit (the signal processing circuit 250, for example) uses pixel signals of the pixels, so that AF by the image plane phase difference method can be realized. Note that only a part of all the R pixels of the pixel array unit 230 is used for AF. Further, signals of the G pixels and the B pixels can be used for AF instead of the R pixels.

FIG. 40 is a block diagram illustrating an example of the configuration of the pixel block 302 in which visible light pixels are arranged according to the sixth embodiment of the present technology. The pixel block 302 according to the sixth embodiment is different from that of the fifth embodiment in that the pixel block 302 does not include the counters 343 and 344 and the switches 353 and 354, and further includes a circuit block 400.

Note that the configuration of the pixel block in which visible light pixels that are not used for AF are arranged is similar to that of the fifth embodiment, and a counter is disposed for each pixel.

The circuit block 400 calculates a logical sum of the pulse signals Pr1 and Pr2 from the R pixels 315-1 and 315-2 and a logical sum of the pulse signals Pr3 and Pr4 from the R pixels 315-3 and 315-4. The circuit block 400 outputs the pulse signal Pr1 or Pr2, or a logical sum thereof to the counter 341 as an input signal CINr1. Further, the circuit block 400 outputs the pulse signal Pr3 or Pr4, or a logical sum thereof to the counter 342 as an input signal CINr2.

The counter 341 according to the sixth embodiment counts the number of input signals CINr1 and outputs the count value as a CNTrl to the switch 351. The counter 342 according to the sixth embodiment counts the number of input signals CINr2 and outputs the count value as a CNTr2 to the switch 352. Further, the counters 341 and 342 are initialized by reset signals RSTr1 and RSTr2, respectively.

The switch 351 of the sixth embodiment outputs the count value CNTr1 to the column buffer 240 via the vertical signal line 309-1 in accordance with the selection signal SEL. The switch 352 of the sixth embodiment outputs the count value CNTr2 to the column buffer 240 via the vertical signal line 309-2 in accordance with the selection signal SEL.

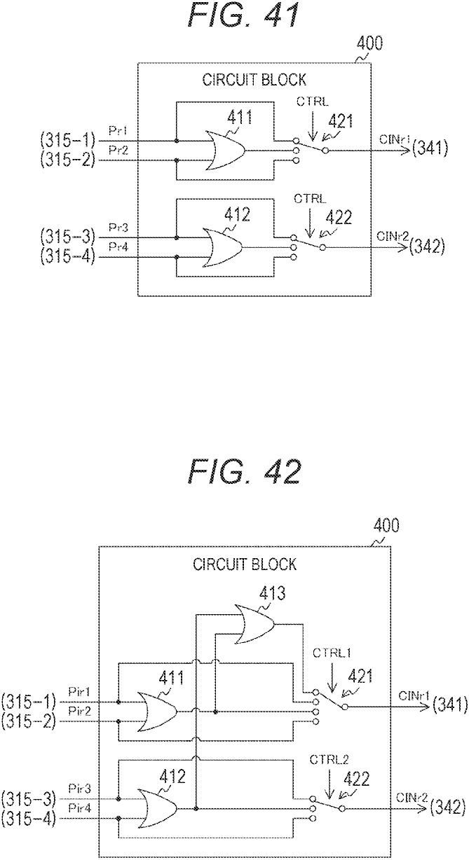

FIG. 41 is a circuit diagram illustrating an example of the configuration of the circuit block 400 according to the sixth embodiment of the present technology. The circuit block 400 includes OR gates 411 and 412 and selectors 421 and 422.

The OR gate 411 outputs a logical sum of the pulse signals Pr1 and Pr2 to the selector 421. The OR gate 412 outputs a logical sum of the pulse signals Pr3 and Pr4 to the selector 422. Note that the OR gates 411 and 412 are examples of first and second logical sum gates described in the claims.

The selector 421 outputs, in accordance with the control signal CTRL, any of the pulse signal Pr1, the pulse signal Pr2, and the output of the OR gate 411 to the counter 341 as the input signal CINr1. The selector 422 outputs, in accordance with the control signal CTRL, any of the pulse signal Pr3, the pulse signal Pr4, and the output of the OR gate 412 to the counter 342 as the input signal CINr2. Note that the selectors 421 and 422 are examples of first and second selectors described in the claims.

The selectors 421 and 422 select a logical sum in a case where AF is performed, and sequentially select pulse signals other than the logical sum in a case where AF is not performed. Then, at the selection of the logical sum, the signal processing circuit 250 detects the focus by the image plane phase difference method on the basis of the output waveform of each of the pair of R pixels.

As illustrated in FIGS. 39 to 41, a visible light pixel receives a pair of incident light subjected to pupil division; thereby the signal processing circuit 250 can perform AF in the image plane phase difference method.

Note that, in the sixth embodiment, the second modification example to the fifth embodiment can be applied to a pixel block in which visible light pixels that are not used in AF are arranged.

Further, in the sixth embodiment, the selectors 421 and 422 can also output a logical sum of two visible light pixels (the R pixels 315-1 and 315-2, and the like) as a value obtained by adding the two pixels.

As described above, according to the sixth embodiment of the present technology, since a visible light pixel receives a pair of incident light subjected to pupil division, it is possible to perform AF by the image plane phase difference method using the pixel signal.

### Modification Example

In the sixth embodiment described above, the signal processing circuit 250 performs AF using the pixel signals of the R pixels 315-1 to 315-4 and the like; however, a four-pixel addition cannot be performed. The solid-state imaging element 200 according to the modification example to the sixth embodiment is different from that of the sixth embodiment in that pixel addition is performed on four pixels.

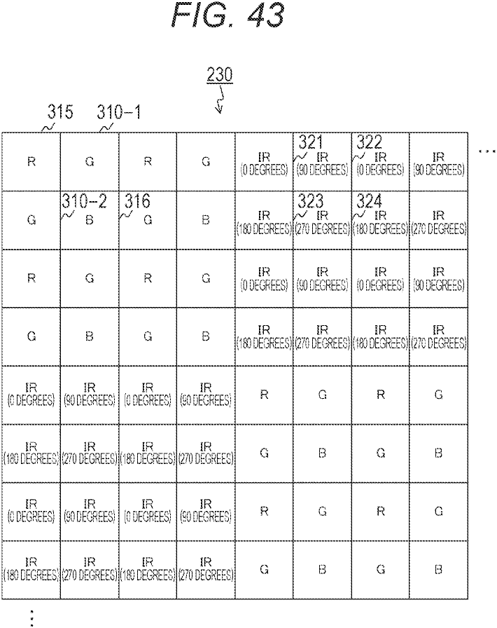

FIG. 42 is a circuit diagram illustrating an example of the configuration of the circuit block 400 according to the modification example to the sixth embodiment of the present technology. The circuit block 400 according to the modification example to the sixth embodiment is different from that of the sixth embodiment in that the circuit block 400 further includes an OR gate 413.

The OR gate 413 outputs a logical sum of signals from the individual OR gates 411 and 412 to the selector 421. Note that the OR gate 413 is an example of a third logical sum gate described in the claims.

Further, the selector 421 according to the modification example to the sixth embodiment selects, in accordance with the control signal CTRL1, any of a signal from the OR gate 413, the pulse signal Pir1, the pulse signal Pir2, and an output of the OR gate 411. The selector 422 according to the modification example to the sixth embodiment selects a signal in accordance with the control signal CTRL2.

Further, in the modification example to the sixth embodiment, the imaging mode includes the addition mode in which pixel addition is performed and the non-addition mode in which no pixel addition is performed.

With the configuration illustrated in FIG. 42, in the addition mode, the selector 421 can output the signal from the OR gate 413 as a value obtained by adding four pixels. Further, in the addition mode, the selectors 421 and 422 can output the signals from the OR gates 411 and 412 as a value obtained by adding two pixels. This enables addition of two pixels or four pixels in the addition mode.

As described above, according to the modification example to the sixth embodiment of the present technology, since the OR gate outputs the logical sum of the pulse signals of four pixels to the selector 421, in the addition mode, the selector 421 can output a value obtained by adding the four pixels.

### 7. Seventh Embodiment

In the sixth embodiment described above, the IR pixels and the visible light pixels are arranged adjacent to each other in a pixel block of two rows by two columns; however, the IR pixels and the like may be arranged in a region larger than a region of two rows by two columns. The solid-state imaging element 200 according to the seventh embodiment is different from that of the sixth embodiment in that the IR pixels and the like are arranged in a region larger than the region of two rows by two columns.

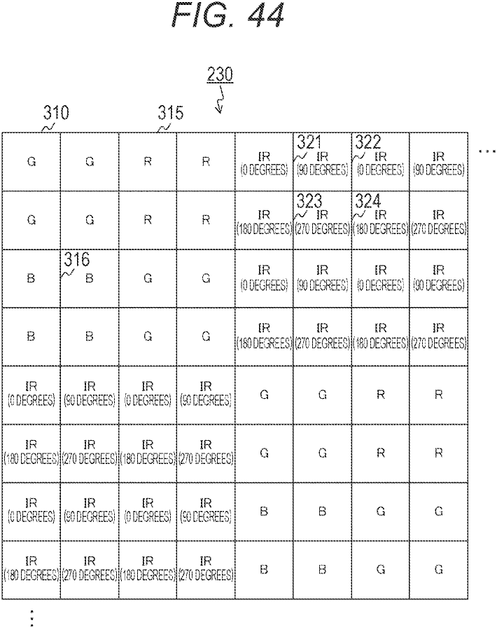

FIG. 43 is an example of a plan view of the pixel array unit 230 according to the seventh embodiment of the present technology. In the pixel array unit 230 of the seventh embodiment, sixteen IR pixels including the IR pixels 321 to 324 are arranged in four rows by four columns. In a case where the distance is calculated every two rows by two columns, four range-finding points are obtained in the region. The signal processing circuit 250 can reduce noise in the depth map by calculating an average or a sum of the measured values of the four range-finding points. Note that a counter can also count the number of pulses for phases more than four phases of 0 degrees, 90 degrees, 180 degrees, and 270 degrees.

Further, R, G, and B pixels are arranged adjacent to each other in four rows by four columns in the Bayer array.

In the seventh embodiment, the configuration including the counter of the region in which the IR pixels are arranged is similar to that of the pixel block in which the IR pixels are arranged in the fifth embodiment. The configuration including the counter of the region in which the visible light pixels are arranged is similar to that of the pixel block in which the visible light pixels are arranged in the fifth embodiment.

Note that any of the second to fifth modification examples to the fifth embodiment, the sixth embodiment, and the modification example to the sixth embodiment can be applied to the seventh embodiment.

As described above, according to the seventh embodiment of the present technology, since the IR pixels are arranged in the region of four rows by four columns, four range-finding points can be acquired for each region. An average of the range-finding points is calculated, so that noise can be reduced.

### 8. Eighth Embodiment

In the seventh embodiment described above, the visible light pixels are arranged in the Bayer array in the region of four rows by four columns; however, in the configuration, there is a possibility that the sensitivity of the pixels is insufficient. The solid-state imaging element 200 according to the eighth embodiment is different from that of the seventh embodiment in that the visible light pixels are arranged in the Quadra array.

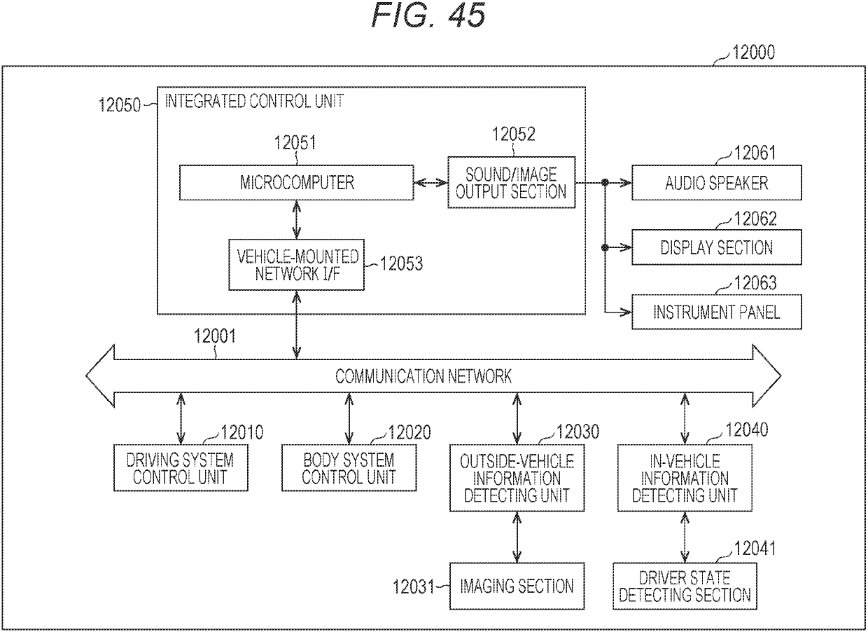

FIG. 44 is an example of a plan view of the pixel array unit 230 according to the eighth embodiment of the present technology. The pixel array unit 230 of the eighth embodiment is different from that of the seventh embodiment in that the visible light pixels are arranged in the Quadra array.

In the Quadra array, the signal processing circuit 250 can improve the sensitivity by performing pixel addition of four adjacent visible light pixels in a dark place or the like.

Note that any of the second to fifth modification examples to the fifth embodiment, the sixth embodiment, and the modification example to the sixth embodiment can be applied to the seventh embodiment.

As described above, according to the eighth embodiment of the present technology, since the visible light pixels are arranged in the Quadra array, the signal processing circuit 250 can improve the sensitivity by performing pixel addition of four adjacent pixels.

### Application Example to Mobile Object

The technology according to the present disclosure (the present technology) can be applied to various products. For example, the technology according to the present disclosure may be implemented as a distance measuring device mounted on any type of mobile object as an automobile, an electric vehicle, a hybrid electric vehicle, a motorcycle, a bicycle, a personal mobility, an airplane, a drone, a ship, a robot, and so on.

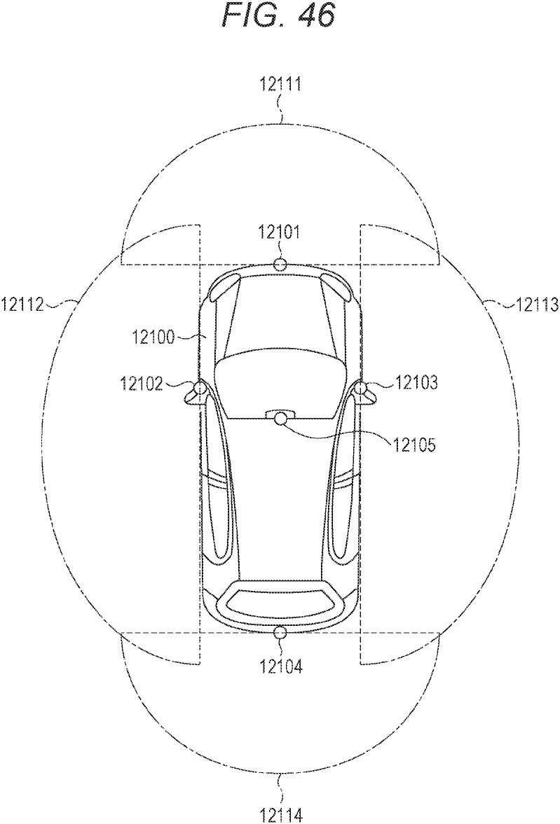

FIG. 45 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 45, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 45, an audio speaker 12061, a display section 12062, and an instrument panel 12063 are illustrated as the output device. The display section 12062 may, for example, include at least one of an on-board display and a head-up display.

FIG. 46 is a diagram depicting an example of the installation position of the imaging section 12031.

In FIG. 46, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle, and the like. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 46 depicts an example of imaging ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird’s-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology according to the present disclosure can be applied to, for example, the imaging section 12031 of the configuration described above. Specifically, the solid-state imaging element 200 in FIG. 3 can be applied to the imaging section 12031. The technology according to the present disclosure is applied to the imaging section 12031 to enable distance measurement without adding a sensor; therefore, the power consumption and cost of the vehicle control system can be reduced.

Note that the embodiment described above illustrates an example for embodying the present technology, and the matters in the embodiment and the matters specifying the invention in the claims have a correspondence relationship. Similarly, the matters specifying the invention in the claims and the matters in the embodiments of the present technology denoted by the same names as the matters specifying the invention have a correspondence relationship. However, the present technology is not limited to the embodiments, and can be embodied by making various modifications to the embodiment without departing from the spirit thereof.

Further, the processing procedures described in the embodiment described above may be regarded as a method including the series of procedures, and may be regarded as a program for causing a computer to execute the series of procedures or a recording medium storing the program. As the recording medium, for example, a compact disc (CD), a mini disc (MD), a digital versatile disc (DVD), a memory card, a Blu-ray (registered trademark) disc, or the like can be used.

Note that the effects described in the present specification are only examples and are not limitative ones, or there may be other effects.

Note that the present technology may also be configured as below.

A sensing system including:
a light emitting unit configured to apply invisible light in synchronization with a predetermined light emission control signal;
an invisible light pixel configured to photoelectrically convert reflected light with respect to the invisible light to generate a pulse signal as an invisible light pulse signal;
a visible light pixel configured to photoelectrically convert visible light to generate a pulse signal as a visible light pulse signal; and
a counting unit configured to perform processing for counting a number of the visible light pulse signals and perform processing for counting, in synchronization with the light emission control signal, a number of the invisible light pulse signals.

The sensing system according to (1) described above, in which
the visible light pixel includes first, second, and third visible light pixels that photoelectrically convert visible light different from each other,
the invisible light pixel includes first, second, third, and fourth invisible light pixels correlated with enable signals of which phase difference with respect to the light emission control signal differs from each other,
the first, second, third, and fourth invisible light pixels are arranged adjacent to each other, and
the first, second, and third visible light pixels are arranged near the first invisible light pixel.

The sensing system according to (2) described above, in which

the counting unit includes a counter configured to perform, in a predetermined order, processing for counting the number of the visible light pulse signals of each of the first, second, and third visible light pixels and perform processing for counting the number of the invisible light pulse signals.

The sensing system according to claim (2) described above, in which
the counting unit includes
a first counter configured to count the number of the visible light pulse signals of the first visible light pixel,
a second counter configured to count the number of the visible light pulse signals of the second visible light pixel,
a third counter configured to count the number of the visible light pulse signals of the third visible light pixel, and
a fourth counter configured to count the number of the invisible light pulse signals in synchronization with the light emission control signal.

The sensing system according to (1) described above, in which
the visible light pixel includes first, second, and third visible light pixels that photoelectrically convert same visible light,
the invisible light pixel includes first, second, third, and fourth invisible light pixels correlated with enable signals of which phase difference with respect to the light emission control signal differs from each other, and
the first, second, and third visible light pixels are arranged near the first invisible light pixel.

The sensing system according to (5) described above, in which
the counting unit includes
a selector configured to sequentially select, as an input signal, the visible light pulse signal of each of the first, second, and third visible light pixels,
a first counter configured to count a number of the input signals, and
a second counter configured to count a number of the invisible light pulse signals in synchronization with the light emission control signal.

The sensing system according to (5) described above, in which
the counting unit includes
a logical sum gate configured to output a logical sum of the invisible light pulse signal of each of the first, second, and third visible light pixels,
a selector configured to select, as an input signal, any of the invisible light pulse signal of each of the first, second, and third visible light pixels, the logical sum, and the visible light pulse signal, and
a counter configured to count a number of the input signals.

The sensing system according to (1) described above, in which
the visible light pixel includes a red (R) pixel, a green (G) pixel, and a blue (B) pixel, and
the invisible light pixel is arranged at a position of the G pixel in a Bayer array.

The sensing system according to (1) described above, in which
the invisible light pixel includes a plurality of invisible light pixels correlated with enable signals of which phase difference with respect to the light emission control signal differs from each other, and
the plurality of invisible light pixels is arranged in a predetermined direction.

The sensing system according to (9) described above, in which

the visible light pixel is inserted between each of the plurality of invisible light pixels.

The sensing system according to (1) described above, in which
the visible light pixel includes first, second, third, and fourth visible light pixels that are arranged adjacent to each other,
the invisible light pixel includes first, second, third, and fourth invisible light pixels that are arranged adjacent to each other, and
the first, second, third, and fourth visible light pixels photoelectrically convert visible light different from each other.

The sensing system according to (11) described above, in which

the counting unit includes a plurality of counters that counts the number of the invisible light pulse signals in synchronization with enable signals of which phase difference with respect to the light emission control signal differs from each other.

The sensing system according to (11) described above, in which
the counting unit includes
a selector configured to select, as an input signal, any of the visible light pulse signal of each of the first, second, and third visible light pixels, and
a counter configured to count a number of the input signals.

The sensing system according to (11) described above, in which
the counting unit includes
a first counter configured to count a number of the invisible light pulse signals in synchronization with a first enable signal in which a phase difference with respect to the light emission control signal is set at 0 degrees or 180 degrees, and
a second counter configured to count a number of the invisible light pulse signals in synchronization with a second enable signal in which a phase difference with respect to the light emission control signal is set at 90 degrees or 270 degrees.

The sensing system according to (11) described above, in which
the counting unit includes
a logical circuit configured to output a logical sum of two or more of the invisible light pulse signal of each of the first, second, third, and fourth invisible light pixels,
a selector configured to select any of the invisible light pulse signal of the first invisible light pixel and the logical sum and output a resultant as an input signal,
a fifth counter configured to count a number of the input signals,
a sixth counter configured to count the number of the invisible light pulse signals of the second invisible light pixel,
a seventh counter configured to count the number of the invisible light pulse signals of the third invisible light pixel, and
an eighth counter configured to count the number of the invisible light pulse signals of the fourth invisible light pixel.

The sensing system according to (11) described above, in which
the counting unit includes
a logical circuit configured to output a logical product of a logical sum of the invisible light pulse signal of each of the first, second, third, and fourth invisible light pixels and each of first and second enable signals of which phase difference with respect to the light emission synchronization signal differs from each other,
a selector configured to select any of the invisible light pulse signal of the first invisible light pixel and the logical product and output a resultant as an input signal,
a fifth counter configured to count a number of the input signals,
a sixth counter configured to count the number of the invisible light pulse signals of the second invisible light pixel,
a seventh counter configured to count the number of the invisible light pulse signals of the third invisible light pixel, and
an eighth counter configured to count the number of the invisible light pulse signals of the fourth invisible light pixel.

The sensing system according to (11) described above, in which
the counting unit includes
a logical circuit configured to output a logical product of a logical sum of the invisible light pulse signal of each of the first, second, third, and fourth invisible light pixels and each of first and second enable signals of which phase difference with respect to the light emission synchronization signal differs from each other,
a selector configured to select any of the invisible light pulse signal of the first invisible light pixel and the logical product corresponding to the first enable signal and output a resultant as an input signal,
a switch configured to output the logical product corresponding to the first enable signal in accordance with a predetermined control signal,
a fifth counter configured to count a number of the input signals, and
a sixth counter configured to perform counting on the basis of the logical product outputted by the second switch.

The sensing system according to (1) described above, in which
the visible light pixel includes first, second, third, and fourth visible light pixels that are arranged adjacent to each other,
the invisible light pixel includes first, second, third, and fourth invisible light pixels that are arranged adjacent to each other, and
the first, second, third, and fourth visible light pixels photoelectrically convert same visible light.

The sensing system according to (18) described above, in which
the first and second visible light pixels receive one of a pair of incident light subjected to pupil division,
the third and fourth visible light pixels receive the other of the pair of incident light subjected to the pupil division, and
the counting unit includes
a first logical sum gate configured to output, as a first logical sum, a logical sum of the visible light pulse signal of each of the first and second visible light pixels,
a first selector configured to select any of the first logical sum and the visible light pulse signal of each of the first and second visible light pixels and output a resultant as a first input signal,
a second logical sum gate configured to output, as a second logical sum, a logical sum of the visible light pulse signal of each of the third and fourth visible light pixels,
a second selector configured to select any of the second logical sum and the visible light pulse signal of each of the third and fourth visible light pixels and output a resultant as a second input signal,
a first counter configured to count a number of the first input signals, and
a second counter configured to count a number of the second input signals.

The sensing system according to (19) described above, in which
the counting unit further includes a third logical gate configured to output, as a third logical sum, a logical sum of the first logical sum and the second logical sum to the first selector, and
the first selector selects any of the third logical sum, the first logical sum, and the visible light pulse signal of each of the first and second visible light pixels.

The sensing system according to (1) described above, in which
the visible light pixel includes first, second, and third visible light pixels that photoelectrically convert visible light different from each other,
the invisible light pixel includes first, second, third, and fourth invisible light pixels correlated with enable signals of which phase difference with respect to the light emission control signal differs from each other,
the first, second, and third visible light pixels are arranged in a first region of four rows by four columns in the Bayer array, and
the first, second, third, and fourth invisible light pixels are arranged in a second region of four rows by four columns.

The sensing system according to (1) described above, in which
the visible light pixel includes first, second, and third visible light pixels that photoelectrically convert visible light different from each other,
the invisible light pixel includes first, second, third, and fourth invisible light pixels correlated with enable signals of which phase difference with respect to the light emission control signal differs from each other,
the first visible light pixel is arranged in a first region of two rows by two columns,
the second visible light pixel is arranged in a second region of two rows by two columns,
the third visible light pixel is arranged in a third region of two rows by two columns, and
the first, second, third, and fourth invisible light pixels are arranged in a fourth region of four rows by four columns.

### REFERENCE SIGNS LIST

100 Sensing system
110 Light emitting unit
120 Driver 130 Controller
140 Processor
150 Application processor
200 Solid-state imaging element
201 Pixel chip
202 Circuit chip
210 Pixel drive unit
220 Vertical scanning circuit
230 Pixel array unit
240 Column buffer
250 Signal processing circuit
260 Output unit
301 to 307 Pixel block
310, 310-1, 310-2 G pixel
311 SPAD
312 Resistor
313 Inverter
315, 315-1, 315-2, 315-3, 315-4 R pixel
316 B pixel
321 to 324 IR pixel
330 Counting unit
341 to 348 Counter
351 to 358, 395 Switch
370, 400 Circuit block
371 to 374, 411 to 413 OR (logical sum) gate
381 to 384 AND (logical product) gate
391 to 393, 421, 422 Selector
12031 Imaging section

1. A sensing system comprising:
a light emitting unit configured to apply invisible light in synchronization with a predetermined light emission control signal;
an invisible light pixel configured to photoelectrically convert reflected light with respect to the invisible light to generate a pulse signal as an invisible light pulse signal;
a visible light pixel configured to photoelectrically convert visible light to generate a pulse signal as a visible light pulse signal; and
a counting unit configured to perform processing for counting a number of the visible light pulse signals and perform processing for counting, in synchronization with the light emission control signal, a number of the invisible light pulse signals.

2. The sensing system according to claim 1, wherein
the visible light pixel includes first, second, and third visible light pixels that photoelectrically convert visible light different from each other,
the invisible light pixel includes first, second, third, and fourth invisible light pixels correlated with enable signals of which phase difference with respect to the light emission control signal differs from each other,
the first, second, third, and fourth invisible light pixels are arranged adjacent to each other, and
the first, second, and third visible light pixels are arranged near the first invisible light pixel.

3. The sensing system according to claim 2, wherein
the counting unit includes a counter configured to perform, in a predetermined order, processing for counting the number of the visible light pulse signals of each of the first, second, and third visible light pixels and perform processing for counting the number of the invisible light pulse signals.

4. The sensing system according to claim 2, wherein
the counting unit includes
a first counter configured to count the number of the visible light pulse signals of the first visible light pixel,
a second counter configured to count the number of the visible light pulse signals of the second visible light pixel,
a third counter configured to count the number of the visible light pulse signals of the third visible light pixel, and
a fourth counter configured to count the number of the invisible light pulse signals in synchronization with the light emission control signal.

5. The sensing system according to claim 1, wherein
the visible light pixel includes first, second, and third visible light pixels that photoelectrically convert same visible light,
the invisible light pixel includes first, second, third, and fourth invisible light pixels correlated with enable signals of which phase difference with respect to the light emission control signal differs from each other, and
the first, second, and third visible light pixels are arranged near the first invisible light pixel.

6. The sensing system according to claim 5, wherein
the counting unit includes
a selector configured to sequentially select, as an input signal, the visible light pulse signal of each of the first, second, and third visible light pixels,
a first counter configured to count a number of the input signals, and
a second counter configured to count a number of the invisible light pulse signals in synchronization with the light emission control signal.

7. The sensing system according to claim 5, wherein
the counting unit includes
a logical sum gate configured to output a logical sum of the invisible light pulse signal of each of the first, second, and third visible light pixels,
a selector configured to select, as an input signal, any of the invisible light pulse signal of each of the first, second, and third visible light pixels, the logical sum, and the visible light pulse signal, and
a counter configured to count a number of the input signals.

8. The sensing system according to claim 1, wherein
the visible light pixel includes a red (R) pixel, a green (G) pixel, and a blue (B) pixel, and
the invisible light pixel is arranged at a position of the G pixel in a Bayer array.

9. The sensing system according to claim 1, wherein
the invisible light pixel includes a plurality of invisible light pixels correlated with enable signals of which phase difference with respect to the light emission control signal differs from each other, and
the plurality of invisible light pixels is arranged in a predetermined direction.

10. The sensing system according to claim 9, wherein
the visible light pixel is inserted between each of the plurality of invisible light pixels.

11. The sensing system according to claim 1, wherein
the visible light pixel includes first, second, third, and fourth visible light pixels that are arranged adjacent to each other,
the invisible light pixel includes first, second, third, and fourth invisible light pixels that are arranged adjacent to each other, and
the first, second, third, and fourth visible light pixels photoelectrically convert visible light different from each other.

12. The sensing system according to claim 11, wherein
the counting unit includes a plurality of counters that counts the number of the invisible light pulse signals in synchronization with enable signals of which phase difference with respect to the light emission control signal differs from each other.

13. The sensing system according to claim 11, wherein
the counting unit includes
a selector configured to select, as an input signal, any of the visible light pulse signal of each of the first, second, and third visible light pixels, and
a counter configured to count a number of the input signals.

14. The sensing system according to claim 11, wherein
the counting unit includes
a first counter configured to count a number of the invisible light pulse signals in synchronization with a first enable signal in which a phase difference with respect to the light emission control signal is set at 0 degrees or 180 degrees, and
a second counter configured to count a number of the invisible light pulse signals in synchronization with a second enable signal in which a phase difference with respect to the light emission control signal is set at 90 degrees or 270 degrees.

15. The sensing system according to claim 11, wherein
the counting unit includes
a logical circuit configured to output a logical sum of two or more of the invisible light pulse signal of each of the first, second, third, and fourth invisible light pixels,
a selector configured to select any of the invisible light pulse signal of the first invisible light pixel and the logical sum and output a resultant as an input signal,
a fifth counter configured to count a number of the input signals,
a sixth counter configured to count the number of the invisible light pulse signals of the second invisible light pixel,
a seventh counter configured to count the number of the invisible light pulse signals of the third invisible light pixel, and
an eighth counter configured to count the number of the invisible light pulse signals of the fourth invisible light pixel.

16. The sensing system according to claim 11, wherein
the counting unit includes
a logical circuit configured to output a logical product of a logical sum of the invisible light pulse signal of each of the first, second, third, and fourth invisible light pixels and each of first and second enable signals of which phase difference with respect to the light emission synchronization signal differs from each other,
a selector configured to select any of the invisible light pulse signal of the first invisible light pixel and the logical product and output a resultant as an input signal,
a fifth counter configured to count a number of the input signals,
a sixth counter configured to count the number of the invisible light pulse signals of the second invisible light pixel,
a seventh counter configured to count the number of the invisible light pulse signals of the third invisible light pixel, and
an eighth counter configured to count the number of the invisible light pulse signals of the fourth invisible light pixel.

17. The sensing system according to claim 11, wherein
the counting unit includes
a logical circuit configured to output a logical product of a logical sum of the invisible light pulse signal of each of the first, second, third, and fourth invisible light pixels and each of first and second enable signals of which phase difference with respect to the light emission synchronization signal differs from each other,
a selector configured to select any of the invisible light pulse signal of the first invisible light pixel and the logical product corresponding to the first enable signal and output a resultant as an input signal,
a switch configured to output the logical product corresponding to the first enable signal in accordance with a predetermined control signal,
a fifth counter configured to count a number of the input signals, and
a sixth counter configured to perform counting on a basis of the logical product outputted by the second switch.

18. The sensing system according to claim 1, wherein
the visible light pixel includes first, second, third, and fourth visible light pixels that are arranged adjacent to each other,
the invisible light pixel includes first, second, third, and fourth invisible light pixels that are arranged adjacent to each other, and
the first, second, third, and fourth visible light pixels photoelectrically convert same visible light.

19. The sensing system according to claim 18, wherein
the first and second visible light pixels receive one of a pair of incident light subjected to pupil division,
the third and fourth visible light pixels receive another of the pair of incident light subjected to the pupil division, and
the counting unit includes
a first logical sum gate configured to output, as a first logical sum, a logical sum of the visible light pulse signal of each of the first and second visible light pixels,
a first selector configured to select any of the first logical sum and the visible light pulse signal of each of the first and second visible light pixels and output a resultant as a first input signal,
a second logical sum gate configured to output, as a second logical sum, a logical sum of the visible light pulse signal of each of the third and fourth visible light pixels,
a second selector configured to select any of the second logical sum and the visible light pulse signal of each of the third and fourth visible light pixels and output a resultant as a second input signal,
a first counter configured to count a number of the first input signals, and
a second counter configured to count a number of the second input signals.

20. The sensing system according to claim 19, wherein
the counting unit further includes a third logical gate configured to output, as a third logical sum, a logical sum of the first logical sum and the second logical sum to the first selector, and
the first selector selects any of the third logical sum, the first logical sum, and the visible light pulse signal of each of the first and second visible light pixels.
